(19) United States
(12) Patent Application Publication
(10) Pub. No.: US 2019/0005457 A1
(43) Pub. Date: Jan. 3, 2019

(54) Systems and methods for establishing employee compensation as convertable options

(71) Applicant: Alan Zimmer, Encinitas, CA (US)

(72) Inventor: Alan Zimmer, Encinitas, CA (US)

(21) Appl. No.: 16/021,994

(22) Filed: Jun. 28, 2018

Related U.S. Application Data
(60) Provisional application No. 62/526,004, filed on Jun. 28, 2017.

(51) Int. Cl. G06Q 10/10; G06Q 40/04

(52) U.S. Cl. CPC G06Q 10/1057; G06Q 10/1053; G06Q 40/04

(57) ABSTRACT

Disclosed is a system and method of providing employee compensation in the form of employee convertible options allowing the employee to utilize the new compensatory security option in new and beneficial ways not provided for in traditional employee options compensation packages.

### CROSS-REFERENCE TO RELATED APPLICATIONS

This application claims the benefit of U.S. Provisional Application No. 62/526,004, filed Jun. 28, 2017.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of systems and methods for employee compensation.

### Glossary of Fundamental Terms

This document presents a glossary of Fundamental terms. The terms are presented in bold and underlined font below:

Bonds—

“A bond is a debt security, in which the authorized issuer owes the holders a debt and, depending on the terms of the bond, is obliged to pay interest (the coupon) and/or to repay the principal at a later date, termed maturity. A bond is a formal contract to repay borrowed money with interest at fixed intervals.” http://en.wikipedia.org/wiki/Bond_(finance)

Convertible Note—

“Or, if it has a maturity of greater than 10 years, a convertible debenture is a type of bond that the holder can convert into shares of common stock in the issuing company or cash of equal value, at an agreed-upon price. It is a hybrid security with debt- and equity-like features. Although it typically has a low coupon rate, the instrument carries additional value through the option to convert the bond to stock, and thereby participate in further growth in the company's equity value. The investor receives the potential upside of conversion into equity while protecting downside with cash flow from the coupon payments.” http://en.wikipedia.org/wiki/Convertible_bond

Common Stock—

“Is a form of corporate equity ownership, a type of security. It is called “common” to distinguish it from preferred stock. In the event of bankruptcy, common stock investors receive their funds after preferred stock holders, bondholders, creditors, etc. On the other hand, common shares on average perform better than preferred shares or bonds over time”.

http://en.wikipedia.org/wiki/Common_stock

Preferred Stock—

“Also called preferred shares, preference shares, or simply preferreds, is a special equity security that has properties of both equity and a debt instrument and is generally considered a hybrid instrument. Preferred are senior (i.e., higher ranking) to common stock, but are subordinate to bonds” http://en.wikipedia.org/wiki/Preferred_stock

Single-Stock Futures (SSF's)—

“Are futures contracts with the underlying asset being one particular stock, usually in batches of 100. When purchased, no transmission of share rights or dividends occurs. Being futures contracts they are traded on margin, thus offering leverage, and they are not subject to the short selling limitations that stocks are. They are traded in various financial markets, including those of the United States, United Kingdom, Spain, India and others. South Africa currently hosts the largest single-stock futures market in the world, trading on average 700,000 contracts daily.” http://en.wikipedia.org/wiki/Single-stock_futures

Stock Warrants—

“Are rights to buy stocks at a certain price until a certain date. They are similar to call options (covered in the next chapter), in that they can be exercised to obtain common shares at a fixed price. The difference is that warrants normally carry a long term limit before they expire (such as five or more years) and when exercised, new common shares are issued by the company to cover the transaction, unlike call options, where the options are based on the already outstanding shares and are created and sold by the shareholders. Warrants are sometimes issued to the previous common shareholders of a company that is just emerging from bankruptcy (at least this is better than nothing). Since normally the exercise price of the warrants is higher than the current stock price, holders must wait until the stock price surpasses the exercise price before they exercise their warrants.” http://www.hashemian.com/financial-markets/stock-warrants-183.htm

Restricted Stock—

“Also known as letter stock or restricted securities, refers to stock of a company that is not fully transferable until certain conditions have been met. Upon satisfaction of those conditions, the stock becomes transferable by the person holding the award.

One type of restricted stock is a form of compensation granted by a company. Typically, the conditions that allow the shares to be transferred are continued employment during a period of time, upon which they vest. However, those restrictions can also be some sort of performance condition, such as the company reaching earnings per share goals or financial targets. Restricted stock is becoming a more prominent form of employee compensation, particularly to executives.[citation needed] It has come to prominence as stock options have fallen out of favor after the perceived excesses of the stock market in the early 21st century.” http://en.wikipedia.org/wiki/Restricted_stock

Employee Stock Option—

“Is a call option on the common stock of a company, issued as a form of non-cash compensation. Restrictions on the option (such as vesting and limited transferability) attempt to align the holder's interest with those of the business' shareholders. If the company's stock rises, holders of options generally experience a direct financial benefit. This gives employees an incentive to behave in ways that will boost the company's stock price.

Employee stock options are mostly offered to management as part of their executive compensation package. They may also be offered to non-executive level staff, especially by businesses that are not yet profitable, insofar as they may have few other means of compensation. Alternatively, employee-type stock options can be offered to non-employees: suppliers, consultants, lawyers and promoters for services rendered. Employee stock options are similar to warrants, which are call options issued by a company with respect to its own stock.

Stock option expensing became a controversy in the early 2000s, and it was eventually determined that by the Financial Accounting Standards Board that the options should be expensed at their fair value as of the grant date.” http://en.wikipedia.org/wiki/Employee_stock_option

Stock Swap—

“Also known as a share swap is a business takeover or acquisition in which the acquiring company uses its own stock to pay for the acquired company. Each shareholder of the newly acquired company receives a certain number of shares of the acquiring company's stock for each share of stock they previously held in the acquired company. Sometimes some shareholders are required to wait for an agreed-upon period of time before they are allowed to sell their new shares of stock.” http://en.wikipedia.org/wiki/Stock_swap

Transferable—

A company prevents employees to transfer ownership of their grants to other parties.

Ability to Pledge—

A company prevents employees to use their ownership of grants as collateral for a loan or other pledgable endeavor.

Derivative Security Utilized to Hedge—

A derivative security (e.g., a future, option, forward, or swap) is a security whose value depends on the value of an underlying asset or variable (e.g., the value of a stock option is based in the valuation of the underlying stock to which it refers). Derivative securities, such as futures and options, are now actively traded on many different organized exchanges in all geographical areas of the world while other derivative securities, such as forwards and swaps, are regularly traded outside of exchanges by financial institutions and their corporate clients in what are referred to as over-the-counter markets.

Financial institutions, as well as individual investors, dealing with options or other derivative securities are primarily concerned with hedging the risk of adverse price and market fluctuations, which may affect their potential returns and/or positions in the underlying asset. Specifically, many financial institutions and individuals utilize listed option and/or over-the-counter option hedging strategies for the following reasons: Liquidity—to generate additional income from an existing equity position and create a measure of downside protection. Risk Reduction- to reduce or eliminate exposure to underlying stock depreciation and protect the value of the equity position. Portfolio Risk Diversification—The process of reducing the risk of a concentrated equity position of an employee by investing in a more balanced and diversified portfolio. Tax Deferral—To avoid triggering a taxable sale of the underlying position; therefore, the capital gains tax associated with an outright sale of the securities is deferred.

Over-the-Counter Options Versus Listed Options—

In general, an option is a contract giving the holder the right, but not the obligation to buy (call) or sell (put) a specified underlying asset at a prearranged price at either a fixed point in the future (European style) or at any time up to maturity (American style). Options are sold both over-the-counter (“OTC”) and on organized exchanges. OTC options are privately negotiated contracts executed outside of the regulated exchange environment. Additionally, there is no central marketplace or clearing house for OTC options. Market-makers, primarily large investment banks and commercial banks, create OTC options for use by a wide range of corporate, individual, and institutional end-users. In contrast, listed equity options trade on organized exchanges. Listed options typically have standardized strike (exercise) prices, maturities and exercise and settlement features. Unless otherwise specified, the options discussed herein are listed options to purchase or sell stock, rather than other options, such as OTC options, index options, foreign currency options, or interest rate options.

Options Clearing Corporation—

Listed options are issued, guaranteed, and cleared by the Options Clearing Corporation (“OCC”). The OCC is regulated by the Securities and Exchange Commission and has received an “AAA” credit rating from Standard & Poor's Corporation. The “AAA” credit rating corresponds to the OCC's ability to fulfill its obligations as counter-party for all listed options trades. The OCC is owned proportionately by the exchanges where listed options trade. The OCC acts as the third party in all listed option transactions and buyers and sellers deal directly with the OCC rather than with each other. The OCC is obligated to the buyer of a listed option contract to ensure that the seller performs in accordance with the terms of the contract and will, in turn, hold the seller's broker-dealer liable for performance on the contract. Listed option contracts are considered to be new issues of securities and are subject to the prospectus requirements of the Securities Act of 1933.

Option Basics—

There are two basic types of options, call options and put options. A call option gives the holder the right to buy 100 shares of the underlying stock from the seller by a certain date for a certain price. If the holder exercises this right, the seller of the call option is obligated to deliver the stock at the predetermined price per share. A put option gives the holder the right to sell 100 shares of the underlying stock to the seller by a certain date for a certain price. If the holder exercises this right, the seller of the listed put option is obligated to buy the stock at the predetermined price per share. The exercise price, also called the strike price, is the price at which the buyer may buy stock from the seller (in the case of a call option) or sell stock to the seller (in the case of a put option).

Components of Listed Equity Options—

A listed option contract is described by the name of the underlying security, the expiration month, the exercise price, and the type of option. The premium represents the market price of the listed option.

For example, a listed call option on GM stock with an exercise price of $35, a January expiration, and a $2 premium would appear as follows: TABLE-US-00001 Underlying Expiration Type of Security Month Exercise Price Option Premium GM January 35 Call 2

Underlying Security—

Each listed equity option represents 100 shares of the underlying stock. In the example above, there are 100 shares of GM stock underlying the listed option contract.

Option Greeks—

Deltas, Vega, Theta, Rho, Gamma

Option Delta—
The delta of an option is the sensitivity of an option price relative to changes in the price of the underlying asset. It tells option traders how fast the price of the option will change as the underlying stock/future moves.

www.optiontradingtips.com/greeks/delta.html

Option Vega—
The Vega of an option indicates how much, theoretically at least, the price of the option will change as the volatility of the underlying asset changes.

www.optiontradingtips.com/greeks/vega.html

Option Theta—
Theta shows how much value the option price will lose for every day that passes.

www.optiontradingtips.com/greeks/theta.html

Option Rho—
Rho is the change in option value that results from movements in interest rates.

www.optiontradingtips.com/greeks/rho.html

Option Gamma—
The gamma of an option indicates how the delta of an option will change relative to a 1 point move in the underlying asset. In other words, the Gamma shows the option delta's sensitivity to market price changes.

www.optiontradingtips.com/greeks/gamma.html

Expiration of Listed Options—

In accordance with the standardized terms of their contracts, all listed equity options expire on a certain date, called the “expiration date.” The holder of the listed option has the right to buy or sell the underlying stock at a time until the expiration date. If the listed option has not been exercised prior to expiration, it will cease to exist. In the example above, the buyer may purchase 100 shares of GM stock form the seller until the expiration date in January.

All listed equity options expire at 11:59 PM EST, on the Saturday following the third Friday of the expiration month. There are however several equity options which aside from on the third Friday also expire on a weekly basis and follows the same procedure as the third Friday. Although the listed equity option does not actually expire until Saturday, customers must initiate their right to buy (in the case of listed call options) or sell (in the case of listed put options) the underlying stock by 4:30 pm EST, on the third Friday of the expiration month or on those stocks which have weekly expiration on every Friday. An expiring listed option will cease trading at 4:02 pm EST on the day prior to expiration. A listed equity option that has not been exercised by 11:59 pm EST on the Saturday following the Friday of the expiration week will expire and become worthless. In order to prevent inadvertent expiration of in-the-money options, the OCC will automatically exercise an option for a customer if the option is in-the-money by 0.01 cents.

It is important to note that the stock may trade above the listed call option's strike price at any time during the life of the listed call option and the listed call option is not automatically exercised. Likewise, the stock may trade below the listed put option's strike price at any time during the life of the listed put option and the listed put option is not automatically exercised.

On occasion buyers do exercise listed equity options before the expiration date, usually only to capture a large dividend on the underlying stock or to participate in a takeover or partial buyout. It is primarily at the expiration of an in-the-money listed equity option that the seller of a listed equity option needs to be concerned about being assigned.

Exercise Price—

the exercise price, also called the strike price, is the price at which the buyer may buy stock from the seller (in the case of a listed call option) or sell stock to the seller (in the case of a listed put option). In the example above, the buyer is guaranteed a purchase price of $35 per share for IBM stock, regardless of how high the price of GM may rise. The aggregate exercise price may be found by multiplying the exercise price by the contract size. The GM January 35 call has an aggregate exercise price of $3500 (100 shares @ $35).

In, At, and Out-of-the-Money—

The relationship between the strike price of a listed option and the current market price of the underlying security has a great influence upon the value of a listed option contract.

In-the-Money—

A listed call option is in-the-money if the market price of the stock is higher than the exercise price of the listed call option.

At-the-Money—

A listed call option is at-the-money if the market price of the stock is the same as the exercise price of the listed call option.

Out-of-the-Money—

A listed call option is out-of-the-money if the market price of the stock is lower than the exercise price of the listed call option.

In-the-Money—

A listed put option is in-the-money if the market price of the stock is lower than the exercise price of the listed put option.

At-the-Money—

A listed put option is at-the-money if the market price is the same as the exercise price of the listed put option.

Out-of-the-Money—

A listed put option is out-of-the-money if the market price of the stock is higher than the exercise price of the listed put option.

Premium—

Premium is the market price of a listed option at a particular time. It is paid by the buyer to the seller for the rights conveyed by the contract. The potential loss to the buyer of a listed option can be no greater than the initial premium paid for the contract, regardless of the performance of the underlying stock. This allows the investor to control the amount of risk assumed. On the contrary, the seller of a listed option, in return for the premium received from the buyer, assumes the risk of being assigned if the contract is exercised. The premium is the only component of the listed option that is not standardized. It is determined on the floor of the exchange between buyers and sellers.

Long Term Equity Anticipation Securities (LEAP)—

LEAPs are similar in all respects to shorter duration equity options, the only distinction is the duration. LEAPs are regulated and cleared by the Options Clearing Corporation (OCC) and regulated and scrutinized by the Securities Exchange Commission (SEC). LEAPs have deep, active markets similar with durations of either 1 or 2 years. LEAPs which have been actively traded since Oct. 5, 1990, and are a well established investment vehicle traded on principal exchanges such as the Chicago Board Options Exchange (CBOE) and the International Stock Exchange (ICE).

Covered Versus Uncovered Call Writing—

The writer or seller of call options may be classified as being either covered or uncovered (also referred to as “naked” call writing). The covered call writer owns the stock underlying the option (or a security convertible into the underlying stock, an escrow receipt, or a long warrant) and is not required to make a margin deposit (e.g., the stock, escrow receipt, convertible security or warrant is considered cover in lieu of the margin otherwise required on a short listed call option position). In addition, covered writing may be done in a margin account or a cash account. The uncovered writer does not own the underlying stock and must meet the short listed call option margin requirement. The basic margin requirement for an uncovered call or put option is the current premium plus 20% of the current market value of the underlying stock minus any amount that the contract is out-of-the-money. Uncovered writing transactions must be done in a margin account.

Covered Call Writing—

This term is less risky than uncovered call writing because if the option is exercised, the investor does not have to go into the market and purchase the underlying stock. The covered writer will simply deliver the shares already owned. The disadvantage to this strategy is that by agreeing to sell the stock owned at the option strike price, the covered call writer forfeits the opportunity to make an unlimited profit if the stock's price advances. Also, the writer of a covered call is still exposed to loss if the market price of the underlying stock declines. In contrast, uncovered call writing is considered to be the riskiest option strategy because an uncovered call writer is exposed to unlimited risk. If the buyer exercises the call, the writer is obligated to deliver the underlying stock. Since the uncovered writer does not own the stock, the investor must first purchase it in the marketplace at the current market price. There is no limit as to how high the price may rise.

Qualified Covered Calls (QCC)—

The rules of a QCC are: “First, the call's strike price must not be too deep in-the-money, which means that the strike price must be close to the closing price for the stock on the previous day. The minimum strike price required for QCC status is usually one strike below the stock's previous day's closing price. In addition, the strike price must be at least 85% of the closing price. Second, options on the underlying stock must be listed on an options exchange. The call in question does not need to be listed, but some option on the underlying stock must be listed. Third, when the investor enters into the call, it must have more than 30 days remaining to expiration but not more than 33 months”. http://www.twenty-first.com/newsletter/newsletter_spring2002-3.htm. The tax advantages will be discussed later.

Long Vertical Call Spreads—

A long vertical call spread is where there is a long call at a lower strike off-set by a short call at a higher strike in the same expiration month. It does not necessary matter whether the two strikes are sequential. Profit is derived when the premium paid—the cost of the long call minus the proceeds of the call sold—is greater than the premium to unwind the position—the sale of the long call and the purchase of the short call. If the underlying stock should at expiration close above the strike price of the short call by 0.01 than the long call is exercised and the short call is assigned and the profit is the difference of the premium paid minus the spread or numerical difference between the two strikes.

Short Vertical Call Spreads—

A short vertical call spread is where there is a short call at a lower strike which is off-set by a long call at a higher strike in the same expiration month. It does not necessary matter whether the two strikes are sequential or non-sequential. The seller of this spread is delivered cash which are the proceeds from the sale of the lower strike call minus the cost of the purchase of the higher strike long call. The maximum profit occurs when the underlying stock at expiration closes below the strike price of the short call or lower strike, the spread than goes out with no value. The maximum loss occurs if the underlying stock should at expiration close above the higher long call strike. The loss is the difference between the proceeds received from the sale of the spread minus the difference in strike price levels.

Long Vertical Put Spreads—

A long vertical spread is where there is a long put at a higher strike off-set by a short put at a lower strike in the same expiration month. It does not necessary matter whether the two strikes are sequential. Profit is derived when the premium paid—the cost of the long put minus the proceeds of the put sold—is less than the premium received to unwind the position—the sale of the long put and the purchase of the short put. If the underlying stock should at expiration close above the strike price of the short put by 0.01 than the long put is exercised and the short put is assigned and the profit is the difference of the premium paid minus the spread or numerical difference between the two strikes.

Short Vertical Put Spreads—

A short vertical put spread is where there is a short put at a higher strike which is off-set by a long put at a lower strike in the same expiration month. It does not necessary matter whether the two strikes are sequential. As with the short vertical call spread with the short vertical put spread the seller of the spread receives proceeds from the sale—the proceeds of the higher strike put sold minus the cost of the lower strike long put purchased. The maximum profit occurs when the underlying stock should at expiration closes above the higher strike price of the short put and goes out with no value. The maximum loss occurs when the underlying stock should at expiration close below the long put strike. The loss is derived from the difference between the proceeds received from the sale of the spread minus the spread difference in strike prices.

Margin Requirements—

Customers purchasing securities may pay for them in full or borrow a portion of the purchase price from the broker-dealer. The amount borrowed from the brokerage firm represents the customer's debit balance. The amount the customer is required to deposit is known as margin. Purchasing securities on margin allows investors to leverage their investments. Leverage involves the ability to increase return with increasing investment.

The extension of credit by a broker-dealer to a customer is regulated by the Federal Reserve Board under Regulation T of the Securities Exchange Act of 1934. Accordingly, option contracts are subject to the margin requirements set forth by the Federal Reserve Board under Regulation T. Regulation T mandates that margin requirements for options are specified by the rules of the registered national securities exchange authorized to trade the option, provided that all such rules have been approved or amended by the Securities and Exchange Commission. Option contracts are also subject to the maintenance requirements of the organized exchanges and each brokerage firm.

It is important to note that under Regulation T, option contracts have no loan value and cannot be purchased on margin. Accordingly, buyers of options must deposit the full purchase price, whether an option is bought in a cash account or a margin account.

Electronic Exchanges Managed by Market-Makers or Specialists—

Option equity exchanges are electronic in all respects and most exchanges rely on market-makers to facilitate trading. A market maker for a certain option is an entity (person or computer program) who will quote both a bid and an ask price on the option when requested to do so by a broker. The bid is the price at which the market maker is prepared to buy and the ask is the price at which the market maker is prepared to sell. The ask is higher than the bid and the amount by which the ask exceeds the bid is referred to as the bid-ask spread. The exchange sets limits for the width of the bid-ask spread. Market makers provide liquidity so buy and sell orders may usually be executed at some price without any significant delays. The market makers themselves make their profits from the bid-ask spread. Public and institutional traders can and will make improvements to the stated markets by placing bids or offers on or inside stated or posted electronic markets.

Margin Requirements of Naked Short Calls or Puts—

The margin requirement for a naked short call or put is 100% of the value of the option plus 20% of the value of the underlying stock.

Margin Requirements Qualified Covered Calls—

None

Cash Requirements Long Vertical Call Spreads—

The cash required is the net premium paid for the spread. The cost of the long call offset by the proceeds from the sale of the call.

Cash Requirements Short Vertical Call Spreads—

The cash required is the difference between the proceeds received from the sale of the spread minus the spread between the two strikes.

Cash Requirements Long Vertical Put Spreads—

The cash required is the net premium paid for the spread. The cost of the long put offset by the proceeds from the sale of the put.

Cash Requirements Short Vertical Put Spreads—

The cash required is the difference between the proceeds received from the sale of the spread minus the spread between the two strikes.

FLexable EXchange Options (FLEX Options)—FLEX option is a transaction which has been in common use since Oct. 24, 1996, and involves the process of a transaction going up on an exchange which is similar to some extend of a an over-the-contract trade. Recognizing the short comings of over-the-counter trades, FLEX trades convert a written contract to a regulated, standardized option contract which is transparent to the SEC and OCC and obtains the following objectives: “Minimization of counterparty credit risk and contract guarantees provided by The Options Clearing Corporation, a triple-A rated central clearing house; Customized contract terms, such as expiration style and date; Price discovery in a competitive auction market with price transparency; The administrative convenience of exchange traded options; Daily closing prices which are set independently by The Options Clearing Corporation; A secondary market to offset positions.

http://www.cboe.com/institutional/IndexFlex.aspx

Individual Retirement Account (IRA)—

The blanket term for a form of retirement plan that provides tax advantages for retirement savings in the United States.

http://en.wikipedia.org/wiki/Individual_Retirement_Account

SEC Rule 10b5-1—

“Rule 10b5-1 has evolved from the Securities Exchange Act of 1934 which was enacted to prohibit the purchase or sale of a security on the basis of non-public information. Here is a more detailed definition: “A regulation enacted by the United States Securities and Exchange Commission (SEC) in 2000. The SEC states that Rule 10b5-1 was enacted in order to resolve an unsettled issue over the definition of insider trading, which is prohibited by SEC Rule 10b-5.

Different courts of appeals had come to different conclusions about what constituted insider trading under Rule 10b-5—specifically, whether someone could be held liable for insider trading simply by trading while in possession of inside information, or whether a trier of fact must find that the person actually used that inside information when making the trade. Paragraph (a) of the Rule essentially repeats the holding of the United States Supreme Court in United States v. O'Hagan, 521 U.S. 642,), which defines insider trading under the misappropriation theory. It states, in full, that: The “manipulative and deceptive devices” prohibited by Section 10(b) of the Act and Rule10b-5 there under include, among other things, the purchase or sale of a security of any issuer, on the basis of material nonpublic information about that security or issuer, in breach of a duty of trust or confidence that is owed directly, indirectly, or derivatively, to the issuer of that security or the shareholders of that issuer, or to any other person who is the source of the material nonpublic information.

Paragraph (b) addresses the unsettled “possession” versus “use” issue, stating that a person violates Rule 10b-5 simply by trading while in “possession” of inside information. It states, in full, that:
Subject to the affirmative defenses in paragraph (c) of this section, a purchase or sale of a security of an issuer is “on the basis of” material nonpublic information about that security or issuer if the person making the purchase or sale was aware of the material nonpublic information when the person made the purchase or sale.[2]

In other words, under 10b5-1(b) a person could be liable for insider trading simply by possessing inside information regarding a given security, breaching a fiduciary duty to the source of the information, and then trading it with a self-serving intent, even if he or she would have made the trade anyway. See U.S. v. O'Hagan, 521 U.S. 642, 652 (1997). But it is unlikely the SEC will detect or particularly care about a small trade that would have occurred anyway. A large trade or series of trades that reap unusual benefits for a trader, however, will likely be detected, and it would be difficult to prove that the material non-public information did not contribute to the decision to make the trade.

In paragraph (c), however, the SEC created an affirmative defense to any charge of insider trading “designed to cover situations in which a person can demonstrate that the material nonpublic information was not a factor in the trading decision.” The provision allows an affirmative defense to insider trading when the trade was made pursuant to a contract, instructions given to another, or a written plan that “[d]id not permit the person to exercise any subsequent influence over how, when, or whether to effect purchases or sales” (10b5-1(c)(1)(i)(B)(3)), and where the plan (or contract or instructions) was created before the person had inside information.

For example, a CEO of a company could call a broker on January 1 and enter into a plan to sell a particular quantity of shares of his company's stock on March 1, find out terrible news about his company on February 1 that will not become public until April 1, and then go forward with the March 1 sale anyway, saving himself from losing money when the bad news becomes public. Under the terms of Rule 10b5-1(b) this is insider trading because the CEO “was aware” of the inside information when he made the trade. But he can assert an affirmative defense under Rule 10b5-1(c), because he planned the trade before he learned the inside information.

After Rule 10b5-1 was enacted, the SEC staff publicly took the position that canceling a planned trade made under the safe harbor does not constitute insider trading, even if the person was aware of the inside information when canceling the trade. The SEC stated that, despite the fact that 10b5-1(c) requires trades to be irrevocable, there can be no liability for insider trading under Rule 10b-5 without an actual securities transaction, based on the U.S. Supreme Court's holding in Blue Chip Stamps v. Manor Drug Stores, 421 U.S. 723 (1975).” http://en.wikipedia.org/wiki/SEC_Rule_10b5-1 (citations omitted)

There are several applicable tenets of Rule 10b5-1 which are particularly relevant to this disclosure and by complying with all requirements afford the employee an “affirmative defense” against accusations of insider trading:

“Establishment of a Plan—
Require company approval of any Rule 10b5-1 plan and permit plans to be established only during an open trading window to avoid the appearance of establishing a plan while in possession of material non-public information and to bolster good faith element.

Waiting Period—
Impose a mandatory waiting period between the establishment of the plan and the date the initial trade is made.

Modifications, Terminations, Suspensions—
Disallow any modification, termination, or suspension other than during open trading windows. In the event of any modification, termination, or suspension, companies should impose a waiting period before trades can be reinstated under a plan.

Disclosure—
Disclose all events in the lifecycle of a Rule 10b5-1plan: adoption, modification, termination, or suspension, either through a press release or by a Form 8-K.

Multiple Plans:
Prohibit insiders from adopting multiple overlapping Rule 10b5-1 plans.

Trades Outside of the Plan—

Once a plan is established, limit transactions outside of the plan. http://www.mofo.com/files/Uploads/Documents/FAQ10b51.pdf

Form 8-K—

Form 8-K is a very broad form used to notify investors of any unscheduled material event that is important to shareholders or the United States Securities and Exchange Commission. This is one of the most common types of forms filed with the SEC. After a significant event like bankruptcy or departure of a CEO, a public company generally must file a Current Report on Form 8-K within four business days to provide an update to previously filed quarterly reports on Form 10-Q and/or Annual Reports on Form 10-K. Form 8-K is required to be filed by public companies with the SEC pursuant to the Securities Exchange Act of 1934, as amended. http://en.wikipedia.org/wiki/Form_8-K

Tradition IRA and Roth IRA Tax Treatment—“Established by the Tax Reform Act (TRA) of 1986, (Pub.L. 99-514, 100 Stat. 2085). A Traditional IRA is an individual retirement account (IRA) in the United States. The IRA is held at a custodian institution such as a bank or brokerage, and may be invested in anything that the custodian allows (for instance, a bank may allow certificates of deposit, and a brokerage may allow stocks and mutual funds). Unlike the Roth IRA, the only criterion for being eligible to contribute to a Traditional IRA is sufficient income to make the contribution. However, the best provision of a Traditional IRA—the tax-deductibility of contributions—has strict eligibility requirements based on income, filing status, and availability of other retirement plans (mandated by the Internal Revenue Service). Transactions in the account, including interest, dividends, and capital gains, are not subject to tax while still in the account, but upon withdrawal from the account, withdrawals are subject to federal income tax (see below for details). This is in contrast to a Roth IRA, in which contributions are never tax-deductible, but qualified withdrawals are tax free. The traditional IRA also has more restrictions on withdrawals than a Roth IRA. With both types of IRA, transactions inside the account (including capital gains, dividends, and interest) incur no tax liability.” http://en.wikipedia.org/wiki/Traditional/IRA

Section 1092 Identified Straddle Rule—

This is an extended ruling by the IRS of how losses are to be recognition of how losses in a straddle are to be treated. “Any loss with respect to 1 or more positions shall be taken into account for any taxable year only to the extent that the amount of such loss exceeds the unrecognized gain (if any) with respect to 1 or more positions which were offsetting positions with respect to 1 or more positions from which the loss arose. (B) Carryover of loss. Any loss which may not be taken into account under subparagraph (A) for any taxable year shall, subject to the limitations under subparagraph (A), be treated as sustained in the succeeding taxable year.” http://www.taxalmanac.org/index.php/Internal_Revenue_Code:Sec._1092._Straddles

Section 16b (the “Short Swing” Rule”) 17 CFR 240.16b-3, b-6

Section 16 is intended to prevent unfair use of inside information and discourage speculative trading by insiders by requiring them to report holdings and transactions in a reporting company's securities (under Section 16(a)). In addition, Section 16 also requires insiders to pay over to the reporting company any “profits” realized from any purchase and sale (or any sale and purchase) of the reporting company securities within a six-month period (under Section 16(b)). Under Section 16(c), insiders are precluded from making short sales (sales of shares they do not own at the time of the sale) of the reporting company's securities. In addition, the SEC requires that the reporting company disclose in its annual proxy statement the names of insiders who have failed to make required Section 16 filings on a timely basis, and also to note the existence of such disclosure on the cover of its annual report on Form 10-K. The rules under Section 16 are complex and contain a number of “gray” areas and potential traps for the unwary. Insiders should consult with counsel before engaging in any transactions in the company's securities, particularly transactions involving “derivative” securities (such as options or warrants).

A short swing rule restricts officers and insiders of a company from making short-term profits at the expense of the firm. It is part of United States federal securities law, and is a prophylactic measure intended to guard against so-called insider tradina.^{[1]} The rule mandates that if an officer, director, or any shareholder holding more than 10% of outstanding shares of a publicly traded company makes a profit on a transaction with respect to the company's stock during a given six-month period, that officer, director, or shareholder must pay the difference back to the company.^{[2]}

As stated by a federal circuit court of appeals:
In order to achieve its goals [of curbing the evils of insider trading], Congress chose a relatively arbitrary rule capable of easy administration. The objective standard of Section 16(b) imposes strict liability upon substantially all transactions occurring within the statutory time period, regardless of the intent of the insider or the existence of actual speculation. This approach maximized the ability of the rule to eradicate speculative abuses by reducing difficulties in proof. Such arbitrary and sweeping coverage was deemed necessary to insure the optimum prophylactic effect.

https://en.wikipedia.org/wiki/Short_swing

### BACKGROUND OF THE INVENTION

Employees of publicly traded companies may have a substantial portion of their net worth concentrated in their company's stock. This stock ownership can be held in several forms of company stock issuances or in derivative securities. For example, the ownership can be held in company bonds, convertible bonds, common stock, preferred stock, warrants, equity options, over-the-counter options, stock swaps.

In addition to owning company stock, sometimes employees of the company are paid by the company in the form of stocks or derivatives. This form of payment is called compensation grants or time-dated compensation grants from the company of either restricted stock (RS), stock appreciation rights (SARS), or employee stock options (ESO). Compensation grants have several limitations depending on the type of stock or derivative included in the grant.

The most common type of compensation grants are RS and ESOs. RS and ESOs have several restrictions that affect recipients of such equity positions from the company as a part of a compensation package. In particular, tax implications, regulatory laws, and avoidance of adverse litigation have generally left few economically efficient alternatives for holders of these equity positions to diversify their risk or to realize more beneficial tax alternatives. Also, there are impediments for holders of employee RS or ESO who seek to generate additional income because, for example, employee grants can be neither pledged nor transferred to someone else. In addition to these limitations, compensation grants of this type are dangerous because improper handling of the stock can place both the company and the employee in jeopardy of fines or other legal punishments.

Employees generally prefer RS grants over ESO grants. On the other hand, companies generally prefer ESO grants over RS grants. This conflict has several causes.

Companies prefer ESO compensation grants over RS compensation grants. One reason for the companies' preference is that ESO grants are said to effectively tie employees to the fortune and future success of the company because the ESOs are not valuable unless the company is successful moving forward after the ESO grant. In other words, a company that pays employees with compensation tied to ESOs have employees that are typically more loyal to the company than other companies that use different forms of compensation. With RS there is not necessarily alignment of the future and fortune success of the company because, as discussed below, the employee can realize the value of the RS almost immediately whereby the employee is not as concerned with the long-term success of the company.

For contrast, restricted stocks are preferred by employees to stock options. Employees are disadvantaged by ESOs in one regard because the need for appreciation of stock value underlying ESOs makes long-term financial planning difficult for the employee paid via ESO grants. For example, it is not possible for an employee who receives a grant of ESOs to strategize revenue for future expenses. Thus, expenses paid out of ESO funds, such as his child's college tuition or practical retirement planning, are nearly impossible to plan.

Another disadvantage of ESOs to an employee is that any appreciated value cannot be partially realized. To the point, if the underlying stock of an ESO should appreciate and the employee wishes to capture some of the monies from this appreciation, the capture of value can only be done by a premature or early exercise of his ESO. Typically, an early exercise of the ESO, forfeits all time premium or value which is embedded into all classes of common stock equity options. In layman terms—“money is left on the table.” The amounts of monies forfeited by employees in this situation are significant and in some cases can equal or exceed the amount captured by the employee from the grant exercise price and the sale price. In most cases, employees have prematurely exercised their employee stock options with many years remaining on the life of the grant.

Even though employees and companies have their preferences regarding ESOs and RS grants, there are still downsides to these types of compensation grants to both companies and employees.

One disadvantage for companies and employees is that it is estimated that 40% of all ESO grants that are in the money (and therefore have value) on the date of expiration of the grant are not exercised and therefore go out worthless. Explanations of inaction by these employees who have received grants could either be due to indifference to their ownership or due to a lack of understanding as to the structure of the grant contract. Regardless, this large number of unexercised grants implies that the ESOs do not benefit the company since many employees appear to be shirking or otherwise misunderstanding their incentive to promote the fortune and future success of the company.

Another downside for employees and companies is that ESOs and RS are not transferable and may have blackout windows where the options cannot be exercised and the stock cannot be redeemed. This means the ESO and RS cannot be used to hedge or otherwise off-set other risks inherent to investments of the employee. Risk aversion or hedging of portfolio investments is no different than other forms of insurance (i.e., a premium paid to lessen the adverse financial impact of an unknown event). So, isolation and restrictions on employees who desire to use ESOs and RS in insurance schemes is inherently arbitrary and improper.

Yet still another downside is that employees do not have the opportunity of converting ESO and RS compensation grants into tax beneficial long term capital gains. This restriction the employee to face unfavorable tax treatment. Employees' profits from ESO and RS are taxed the rate of ordinary income rather than at the rate of investment income. The taxing of such profits is somewhat burdensome since there are no payroll withholdings at the time the employee is granted the ESO or RS and, as a result, the employee is burdened administratively. Further, employees bear the same risk as investing shareholders to adverse movement of the underlying common stock without being taxed at the rate of investment income. This means ESO and RS compensation grant holders are not allowed to realize the same benefits shareholders have by holding common stock or derivatives for long term capital appreciation and the accompanying tax benefits.

Yet still, employees who receive ESO or RS grants are not allowed to integrate them into an Individual Retirement Account (IRA). Employees should receive the same benefits accorded individual investors who have tax advantages in utilizing their IRA to more effectively manage and plan estate and retirement causes.

ESO and RS grants are administratively burdensome to the issuing company. With the enactment of the Dodd-Frank Wall Street Reform and Consumer Protection Act into law on Jul. 21, 2010; it stipulated the need for greater disclosure in the transparency of employee stock compensation grants. It mandated that the manner, method, and timing be more precise and exacting for full disclosure. See, Section 955.

Furthermore, there is no effective methodology for companies, after the issuance of ESO or RS grants, to subsequently plan or strategize this expense obligation over the life of grants to employees. More importantly, companies granting compensation grants of ESO or RS to employees have no method or manner to capture additional revenue or profit from these grants.

Until this disclosure, no one has tried to improve ESO and RS grants in a way that would benefit both the employees and the companies involved in such compensation grants. That said, the prior art has noted a need for improved systems and methods of compensation granting ESOs and RSs. See, e.g., U.S. Pat. No. 7,707,096 and U.S. Pat. No. 8,660,933 which speak to a general notion of a convertible options plan.

### SUMMARY OF THE INVENTION

Accordingly, it is an object of the present document to provide systems and methods for establishing employee compensation as convertible options. In a preferred embodiment, an employee convertible option (ECO) may be defined as either an adjunct instrument or as an alternative to current company grants of RSs or ESOs. In one embodiment, the ECO may accomplish the following tasks:
a. compliance with the Dodd-Frank Wall Street Reform and Consumer Protection Act of 2011 mandates for the company and employee;
b. creation of a cost expense for the company in the form of a compensation award which is recoverable in the ECO Company 10b5-1 Plan, wherein the company would be afforded the opportunity to actually profit from this compensation grant;
c. alignment of valued employees to the company and reduce risk of employees moving to different jobs;
d. allowance of employees to receive cash annually from the ECO as it will be embedded into the ECO Employee's 10b5-1 Plan;
e. allowance of employees to hedge not only ECOs but other issuances of RS or ESO grants or other vested company issuances;
f. allowance of employees to realize profits and losses in a structured ECO IRA
g. transformation of an ECO held the appropriate holding period into long term capital gains on the balance of the employee ECOs held in the ECO Employee's 10b5-1 Plan;
h. avoid the implication of the “short swing” rule; and,
i. enhancement of shareholder value.

It is another object of the present disclosure to provide a method to manage the aspects of the ECO plan. The methodology disclosed in this document includes a company crafted ECO Company 10b5-1 Plan to efficiently hedge the short call positions created in the company's ECO Company 10b5-1 Plan by the ECO conversion to a 5 year Long Term Equity Anticipation Securities (LEAP) calls. LEAP calls are a well-established investment vehicle traded international exchanges and in North America on principal exchanges such as the Chicago Board Options Exchange (CBOE) and the International Stock Exchange (ICE).

It is yet another object of the present written description to provide a use of an IRA able to accept the ECO plan. In one embodiment, employees may use their ECO Employee's 10b5-1 Plan to hedge risk with alternative investments wherein the employee may realize short term gains or short term losses in an approved ECO IRA. In one embodiment, the employee can now capture long term capital gains on the 5 year LEAP calls, in part, because of the employee's ability to defer this risk. Suitably, the employee has the ability to effectively manage all personal portfolio investment assets and tax planning now that the employee has an approved ECO IRA embedded into his ECO Employee's 10b5-1 Plan.

It is yet another object of the present writing to provide a method and system capable of managing the ECO plan through a software package. The preferred embodiment includes ECO Computer Software to manage all aspects of the ECO, ECO Employee's 10b5-1 Plan, the ECO IRA, and the ECO Company 10b5-1 Plan.

It is yet another object of the present discussion to provide different methods for which ECOs may be converted for employee benefit. An ECO would, in one embodiment, be a contract compensation grant with the following features:
a. A conversion of a limited number of ECO to cash under conditions specified in the ECO Employee's 10b5-1 Plan on the date of the each year's grant;
b. For those ECOs not converted to cash, the majority of ECOs will be converted to a regulated LEAP call which would be of a duration of five (5) years, wherein the 5 year LEAP calls would be regulated and cleared by the Options Clearing Corporation (OCC) and regulated by the Securities Exchange Commission (SEC), wherein the 5 year LEAP call will have deep, active markets similar to the 1 and 2 year LEAP calls which have been actively traded on global regulated exchanges since Oct. 5, 1990, wherein only 1 and 2 year LEAPS are traded but with the approval of the SEC a new contract will be created which will be a 5 year LEAP.
c. A FLexable EXchange Options (FLEX Options) transaction, which has been in common use since Oct. 24, 1996, is used to transform the ECO into a 5 year LEAP call wherein after its conversion via this transaction the 5 year LEAP call would be transferable and similar in all respects to the 6 month calls, 9 month calls, and 1 and 2 year LEAP calls currently being traded in the company's underlying common stock family of equity options.

With the conversion of ECO to 5 year LEAP calls the employee is now eligible to hedge his asset with alternative investments without the restrictions that currently exist. The hedging would be under the guidance of the ECO Employee's 10b5-1 Plan. In sum, the converted ECO which has now become a regulated investment asset and has all of the benefits of a regulated equity option by the SEC.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a flow chart for the creation of the Employee Convertible Option Contract Grant.

FIG. 2 is flow chart displaying the creation of a grant account for an Employee Convertible Option 10b5-1 plan for a broker dealer.

FIG. 3 a continuation of the flow chart of FIG. 2.

FIG. 4 is flow chart displaying the methodology to establish the Employee Convertible Option 5 year Long Term Equity Anticipation Securities (LEAP) call strike.

FIG. 5 is a flow chart to schedule conversion of the Employee Convertible Options or sale of the Long Term Equity Anticipation Securities (LEAP) calls.

FIG. 6 is a flow chart describing actions to take with unhedged and sold Employee Convertible Options.

FIG. 7 charts out establishing a yearly price for each Employee Convertible Option.

FIG. 8 is a flow chart for management of Employee Convertible Options converted to 5 year Long Term Equity Anticipation Securities (LEAP) with upper vertical spreads within the Employee Convertible Option Employee 10b5-1 plan.

FIG. 9 is a flow chart for management of Employee Convertible Options converted to 5 year Long Term Equity Anticipation Securities (LEAP) or other vested or restricted assets with downside long put verticals within the Employee Convertible Option Employee 10b5-1 plan.

FIG. 10 is a flow chart representing how cash is moved into and out of for Employee Convertible Option Employee 10b5-1 plan.

FIG. 11 is a flow chart representing how an Employee Convertible Option Employee 10b5-1 plan may be used to buy stock or stock option derivatives if price objectives are met.

FIG. 12 is a flow chart representing how management of FLexable EXchange Options transactions for 5 year Long Term Equity Anticipation Securities (LEAP) calls shall be granted.

FIG. 13 is a flow chart representing how cash dividends and other distributions should be granted to Employee Convertible Option Employee 10b5-1 plan.

FIG. 14 is a flow chart representing the rolls of short upside vertical call spreads.

FIG. 15 is a flow chart representing the rolls of long downside vertical put spreads.

FIG. 16 is a flow chart representing how the Employee Convertible Option Company 10b5-1 plan shall be managed.

FIG. 17 is a flow chart representing how the Employee Convertible Option 10b5-1 plan management software shall function.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

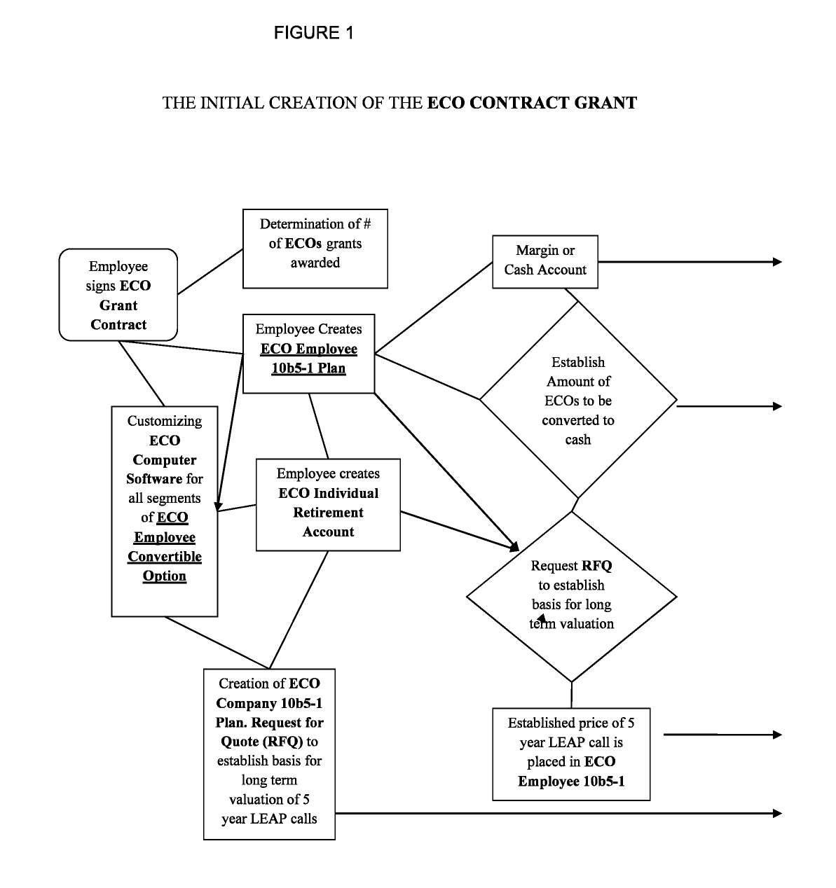

FIG. 1 is a flow chart for the creation of the ECO Contract Grant. As shown: first, an employee signs the ECO Grant Contract. Then, a determination of the number of ECOs awarded is made. At the same time, the employee creates an ECO employee 10b5-1 plan, an IRA, and a request for quote (RFQ). All the while software is customizing the segments of the ECO. During creation of the ECO employee 10b5-1 plan, and the IRA, the employee chooses a margin or cash account, establishes the amount of ECOs to be converted to cash, uses the RF1 to establish a basis for a long term and then places the established price of the 5 year LEAP call in the ECO employee 10b5-1.

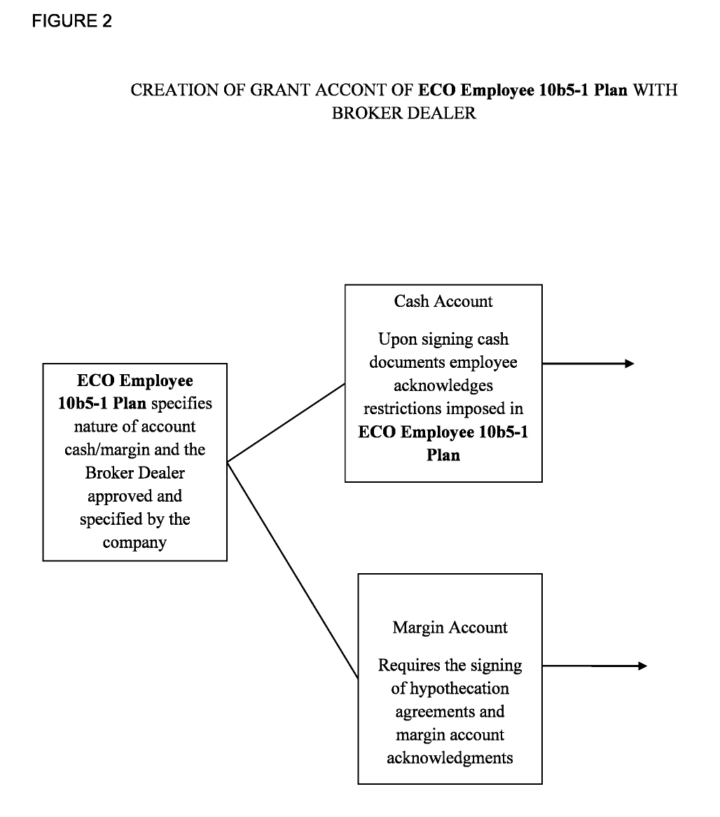

FIG. 2 is flow chart displaying the creation of a grant account for an Employee Convertible Option 10b5-1 plan for a broker dealer. As shown, the ECO employee 10b5-1 plan specific the nature of the account as cash/margin and the broker dealer approved and specified by the company wherein if the ECO employee 10b5-1 plan specifies a cash account, the employee acknowledges restrictions imposed in the 10b5-1 plan or else ECO employee 10b5-1 plan specifies a margin account and the hypothecation agreements and margin account acknowledgments must be signed.

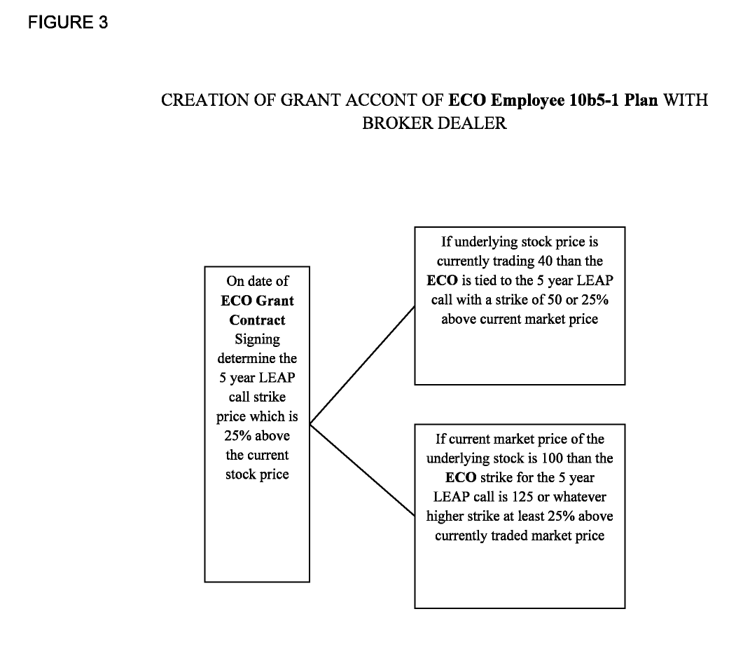

FIG. 3 is a continuation of the flow chart of FIG. 2. In a preferred embodiment, the ECO Grant Contract will be vested for a 5 year period with the employee receiving 20% of the number of grant options which the ECO Grant Contract specifies for each year of the contract. For example, if the employee receives a grant contract of 500 ECOs from his company the employee will receive 100 ECOs in each year of the 5 year contract. The strike price of the ECO Grant Contract will be an out of the money call which will be 25% above the current quoted price of the underlying common stock of the employee's company on the day of the initial ECO Grant Contract.

Here are two examples illustrated in FIG. 3:

Example 1, if the underlying stock is trading at 40 than the grant contract will be a 5 year LEAP call with a strike of 50 or 25% higher.
Example 2, if the underlying stock is trading at 100 than the grant contract will be at 125 or 25% higher and if that strike is not available due to non-listing than the next higher available higher strike of 130.

Referring back to FIG. 2, at the time of the ECO contract signing of the ECO contract grant, the employee will by default be selecting a margin account. The employee alternatively, has the option to specify that his ECO Employee's 10b5-1 Plan be a cash account. Margin accounts typically are established to allow greater leverage but are also necessary for holding short stock. Due to unusual instances of an early assignment of a short call position in the ECO Employee 10b5-1 Plan and embedded IRA Plan, situations might occur intraday where the short stock position is covered and the next hedge is executed on the same day.

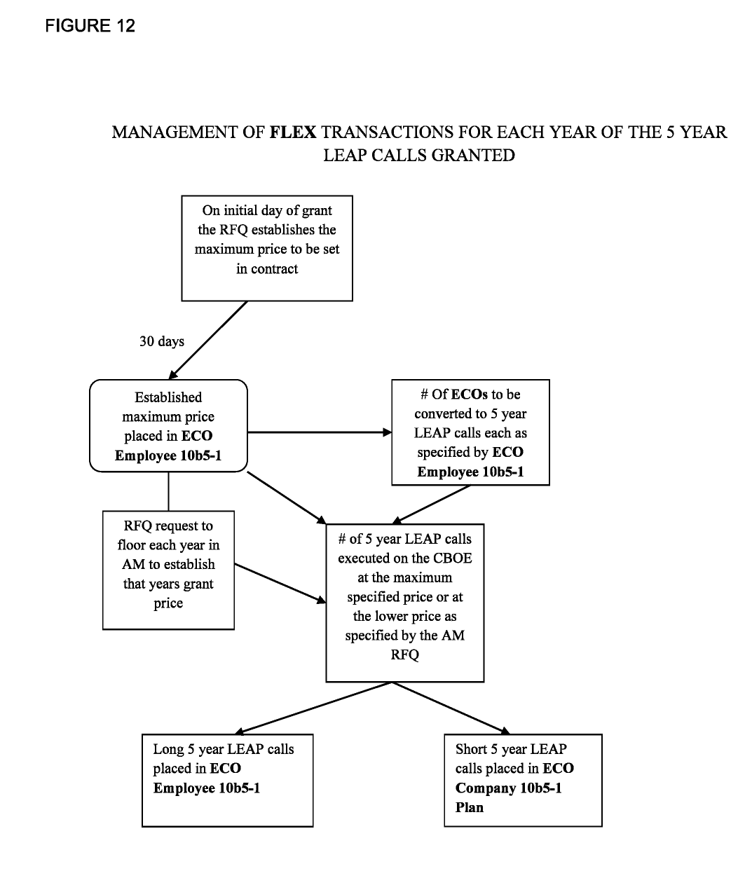

FIG. 12 is a flow chart representing how management of FLexable EXchange Options transactions for 5 year Long Term Equity Anticipation Securities (LEAP) calls shall be granted. As shown, on the first day of the grant contract a maximum price for the 5 year LEAP call of the ECO will be established. This would be done by a Request for Quote (RFQ) made to the CBOE and/or ISE where an established market of active bids and offers is ongoing. If for example, the RFQ comes back with a market is $5 at $5.40. The grant contract will then be set on the bid side of the market or at a maximum price of $5 for the 5 year life of the ECO. This price will be fixed not only in the employees grant contract but also the price which will be imbedded into the mandatory ECO Employee 10b5-1 Plan. In the each subsequent year of the grant contract this would be the maximum allowed price of the ECO to the employee. The Employee Convertible Option (ECO) after the 30 day waiting period recommended by all 10b5-1 Plans the ECO Employee 10b5-1 Plan will convert via a FLEX trade between the employee under his ECO Employee's 10b5-1 Plan and the company's ECO Company 10b5-1 Plan a FLEX transaction. The FLEX trade will be preceded by a RFQ to determine the applicable pricing of that years LEAP call grant. The company will put up the FLEX transaction and the employee will own the LEAP calls in his ECO Employee's 10b5-1 Plan and the company will have a short position in their corporate ECO Company 10b5-1 Plan.

Still referring to FIG. 12, the ECO pricing is fixed in the ECO Contract as a maximum price, not a minimum contract price. The ECO pricing can be priced below the stated price in the ECO Contract Grant. The advantage of a FLEX transaction is that the price of the FLEX trade can be executed at any level. It is not tied to nor does it need to correspond with the currently actively traded market. The distinction is that after the FLEX trade goes up in that trading day but after the close of trading the Options Clearing Corporation will “mark to market” the 5 year LEAP call which was formerly an ECO.

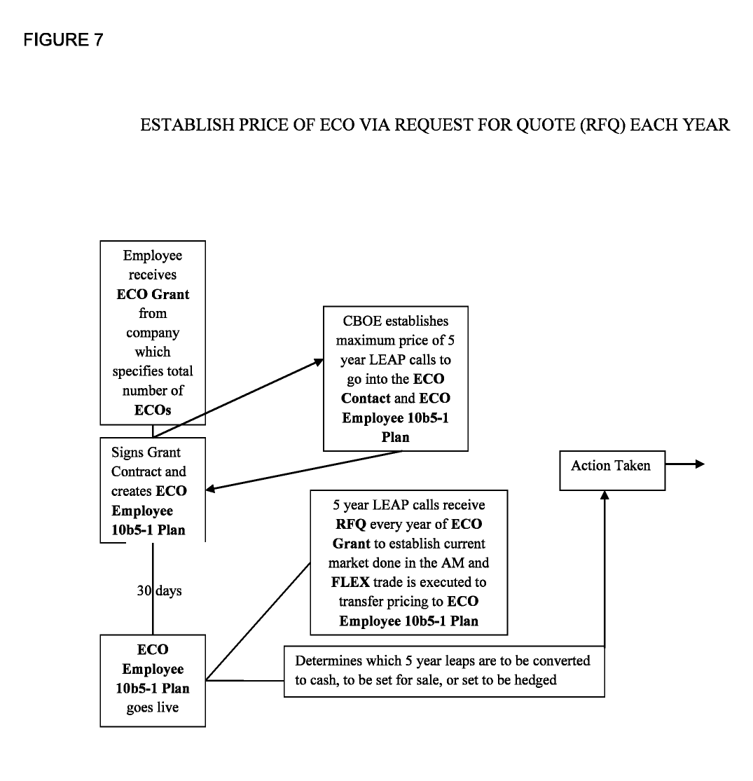

FIG. 7 charts out establishing a yearly price for each Employee Convertible Option. Each subsequent year an RFQ of the current market will be made. Using the example of a stipulated contract ECO price of $5, if in any given year, the RFQ current market is above the current example than the 5 year LEAP calls trade will still go up at the ECO Contract price of $5.

### Example 2

The following actions will be taken after an RFQ is sent to floor and the RFQ quote comes back with a quote of $10 at $10.40 than a Flexible Exchange Option (FLEX) trade of that year's 20% grant will be put up at the established maximum (via the Employee Convertible Option (ECO) Contract) allowable price of $5 on one of the principle exchanges. At the end of that same trading day the Option Clear Corporation (OCC) will “mark to market” the former ECO now converted to a regulated 5 year LEAP calls at the settled price $10.

If in a subsequent year, the bid of the LEAP calls is below the stipulated price in the ECO Contract than the FLEX trade will go up on the bid side of the current market which is below the ECO Contract price.

### Example 3

Given our current example with a ECO Contract price of $5, that after a RFQ the quote comes back with a market which is $3 at $3.40 than the grant contract for that 20% allocation of that year is put up on the bid side of that market via a FLEX trade and the pricing of the 5 year LEAP calls for the that year's grant would be $3. The employee has now converted his ECO to a 5 year LEAP with a cost basis of $3.

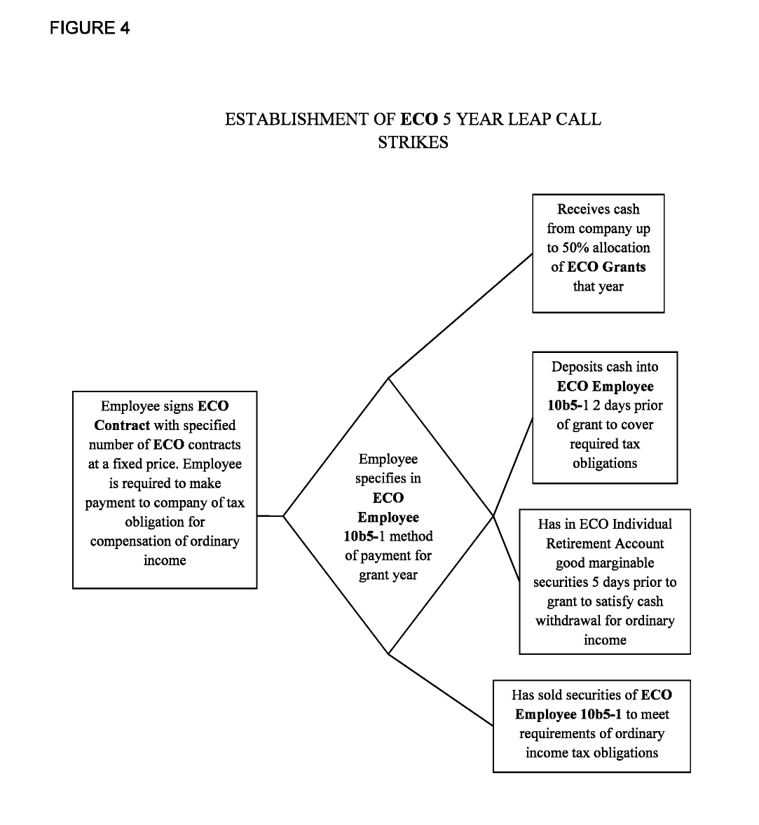

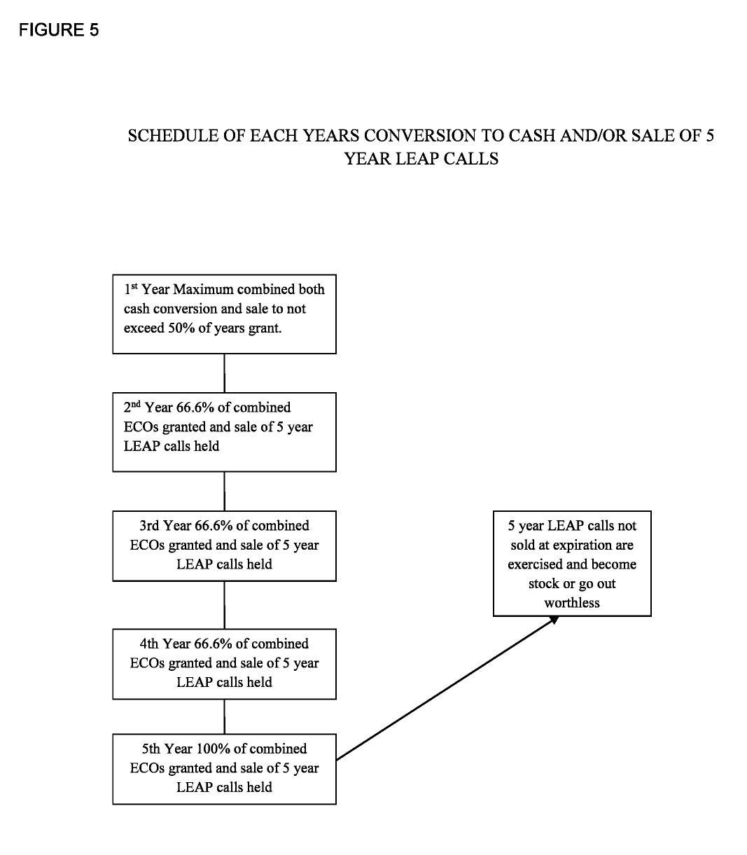

FIG. 4 is flow chart displaying the methodology to establish the Employee Convertible Option 5 year Long Term Equity Anticipation Securities (LEAP) call strike. FIG. 5 is a flow chart to schedule conversion of the Employee Convertible Options or sale of the Long Term Equity Anticipation Securities (LEAP) calls. Referring to that figure, while observing the annual 50% restriction on cash exchange, the ECO Company 10b5-1 Plan will be able: To sell up to 50% of his ECO grant holdings in the 1st year—but the combined exchange for cash and outright sales of 5 year LEAP calls may not exceed 50%; Up to 66.6% in the 2nd year—but the combined exchange for cash and outright sales of 5 year LEAP calls may not exceed 66.6%; Up to 66.6% in the 3rd year—but the combined exchange for cash and outright sales of 5 year LEAP calls may not exceed 66.6%; In the 4th year—but the combined exchange for cash and outright sales of 5 year LEAP calls may not exceed 66.6%; Up to 100% in 5th year. Employee at all times must conduct sales under the contract terms specified in the Employee Convertible Option (ECO) initial contract and the embedded ECO Company 10b5-1 Plan; and, the employee can specify to sell some, hedge some, or hold some of his ECO Employee's 10b5-1 Plan converted 5 year LEAP calls. On expiration day of the 5 year LEAP call contract any contracts not sold will be exercised into long company stock.

Referring now to FIGS. 4 and 5, with the granting of vested stock and vested employee stock options the company withholds taxes at the rate of ordinary income on the date when the employee exercises and sells his grant. Monies withheld by the employee's company and more specifically through the company's Employee Stock Option Plan Administrator are submitted to the employee's applicable state taxing agencies and the Internal Revenue Service. With Employee Convertible Option (ECO) the employee's ECO Employee's 10b5-1 Plan is responsible for transferring to the company all tax obligations at time of issuance of each year's grant. The ECO Employee's 10b5-1 Plan has several conversion alternatives to satisfy this tax obligation:

As shown, The ECO Employee's 10b5-1 Plan will instruct his company to withhold funds from that year's grant and the necessary conversions of the ECOs to cash will be performed to satisfy this requirement—similar in every respect to current practices. The ECO Employee's 10b5-1 Plan would determine how many ECOs would be required to be converted to cash—the number of ECOs to be converted will always be less than 50% of those granted. The remaining ECOs will be converted to 5 year LEAP calls as stipulated earlier. (Example: The ECO Employee's 10b5-1 Plan stipulates that of the company grant of 100ECOs30 ECOs will be converted to cash and transferred to the company to satisfy the tax liability of ordinary income. The remaining 70 ECOs will be converted to 5 year LEAP calls.

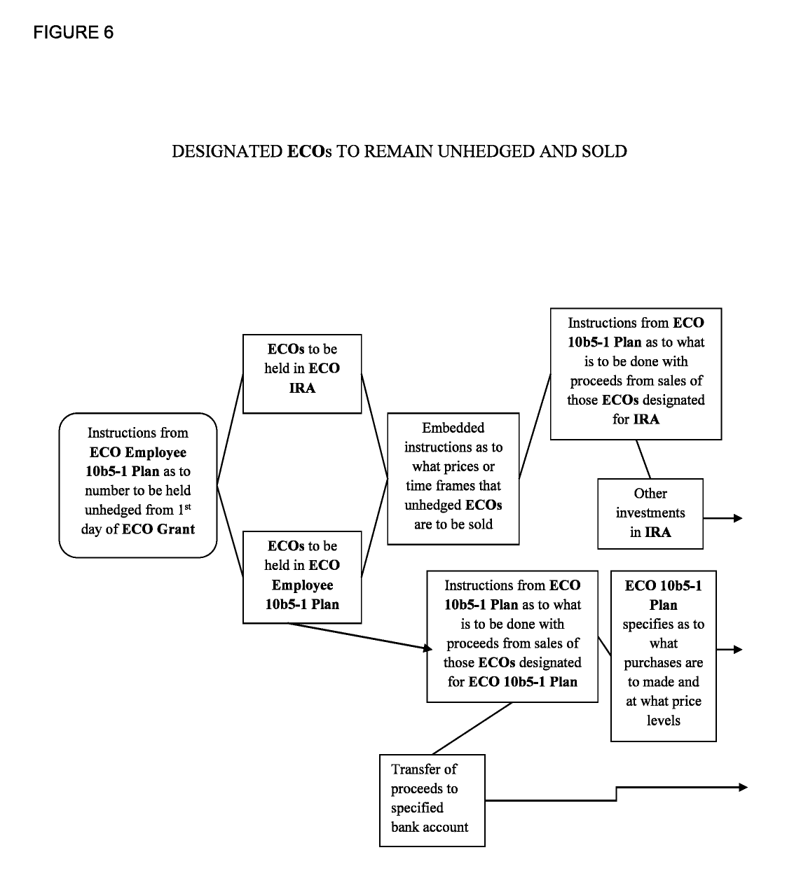

FIG. 6 is a flow chart describing actions to take with unhedged and sold Employee Convertible Options. The ECO Employee's 10b5-1 Plan has the option of selling the appropriate number of ECOs converted to 5 year LEAP calls on the open market to satisfy the ordinary tax liability of that year's grant. (Example) Using our prior example of a $5 maximum grant price where the current market is $25 to $25.40. The EGO Employee's 10b5-1 Plan will sell the appropriate number of $25 5 year LEAP calls he currently owns to satisfy the ordinary income tax requirement for that year's grant but the employee is able to capture long term capital gains from the sale of the current markets $25 5 year LEAP calls pricing from a previous year's grant of ECOs. His new grant will be priced at the maximum ECO Contract price of $5 and that current year's grant will begin its tax cycle on the date of the grant. This conversion will be completed 5 business days prior to the date of each year's grant to insure good delivery.

Referring to FIG. 4, the ECO Employee's 10b5-1 Plan will hold sufficient cash or marginable securities to withdraw sufficient funds from cash account balance to satisfy all tax liabilities of ordinary income for that current year's grant. These funds will be transferred by the ECO Employee's 10b5-1 Plan to the company and be completed 5 business days prior to the date of each year's grant to insure good delivery.

In all cases the tax liability must and will be transferred from the ECO Employee's 10b5-1 Plan to the company 5 days prior to date of the each year's grant.

The employee can authorize the ECO Employee's 10b5-1 Plan to automatically determine which methodology is most advantageous and act accordingly.

As established earlier and as shown in FIG. 6, the employee under terms of the ECO Employee's 10b5-1 Plan is entitled to have some of his ECOs on grant day converted to cash and he is also permitted to sell some of his ECOs each year. Alternatively, if the employee so specifies in his ECO Employee's 10b5-1 Plan he can mandate that all or some of his LEAP calls remain unhedged. Of these unhedged and at risk LEAP calls, the ECO Employee's 10b5-1 Plan could also be structured such that at specific price levels amounts or on specified dates the ECO Employee's 10b5-1 Plan will sell 5 year LEAP calls.

On those not specified for sale or not specified to be held the 5 year LEAP calls the ECO Employee's 10b5-1 Plan will initiate hedges to defer risk and add income. To defer risk and capture income the 5 year LEAP calls can be hedged with short vertical call spreads in 6 month calls, 9 month calls, 1 year, and/or 2 year LEAP calls under specific hedging procedures established by the employee in his ECO Employee's 10b5-1 Plan. The ECO Employee's 10b5-1 Plan will specify which option cycles to sell as a hedge against the 5 year LEAP calls now owned.

### Example 4

The underlying common is trading at 40 the ECO has been converted to a 5 year LEAP with a strike of 50. The ECO Employee's 10b5-1 Plan would issue instructions to sell a 9 month call spread with strikes by selling one 50 call and buying one 60 call. This spread would be done one time for each 5 year LEAP call to be hedged. So if the ECO Employee's 10b5-1 Plan had 50 5 year LEAP calls then selling the vertical call spread 50 times. The advantages of this transaction is that aside from deferring risk and capturing extra income in terms of short term gains the ECO Employee's 10b5-1 Plan is allowing the 5 year LEAP calls to further garner the length of ownership to classify as a long term capital gain while still capturing unlimited upside gains.

By using upside vertical spreads the employee is not forfeiting significant upside profit if the company's underlying common stock should continue to appreciate. Up to a certain level of underlying stock appreciation the long 5 year LEAP calls will perform point for point with the identified short side of this straddle. Then as the underlying common approaches the upside long call of the sold call spread the employee in his ECO Employee's 10b5-1 Plan will be afforded unlimited upside gains as the underlying stock advances beyond the parameters of the short upside vertical spread. A more detailed breakdown of the ECO Employee's 10b5-1 Plan hedging opportunities will have one of three different alternatives of market action affecting the ECO Employee's 10b5-1 Plan at expiration of the short vertical call spread.

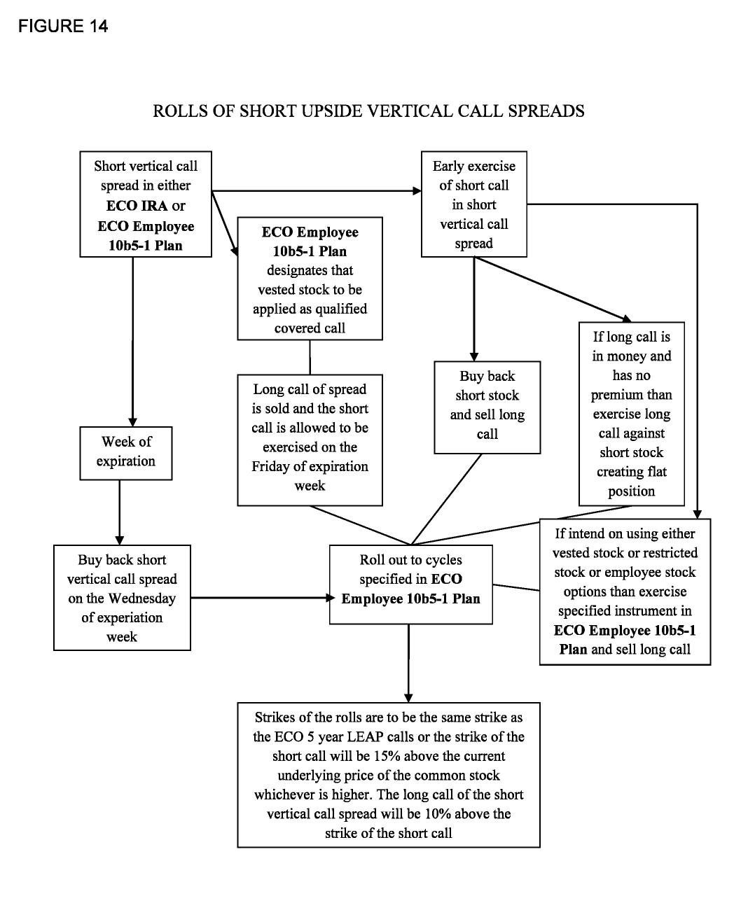

FIG. 14 is a flow chart representing the rolls of short upside vertical call spreads. Referring to FIG. 14 and continuing the example, on the Wednesday of the week of expiration the short vertical call spread will be closed out with purchase of the short call and the sale of the long call. The underlying value of the stock has no bearing. The next designated cycle specified in the ECO Employee 10b5-1 Plan will be sold either in the ECO Employee 10b5-1 Plan or in the ECO Individual Retirement Account as specified in the ECO Employee 10b5-1 Plan. The short strike of the short vertical call spread will be the same as the 5 year LEAP ECO calls or a short strike which is 15% above the underlying value of the common stock whichever is higher. The long call part of the short vertical call spread will be 10% above the strike of the short call.

Prior to expiration, the short contract of the vertical spread receives an early assignment creating a short position of the underlying stock. The ECO Employee's 10b5-1 Plan will via established instructions use vested restricted stock the ECO Employee's 10b5-1 Plan to exercise the appropriate number of shares of restricted stock to maintain a flat or no short position in the underlying common stock. After the exercise of ESOs to flatten the short stock position, the long call of the short vertical call will be sold.

If the employee has no vested stock or does not wish to apply owned vested stock against the short call exercise, than the short stock will be covered by repurchase of the short stock or by exercise of the long call if the long call is in the money and holds no premium over the underlying stock.

If the long call is out of the money than the short stock position created by the early exercise of the short call will be covered by a purchase of stock intraday and the long call sold according to instructions in the ECO Employee's 10b5-1 Plan.

No matter the date but no later than the Wednesday of expiration week the next designated cycle specified in the ECO Employee 10b5-1 Plan will be sold either in the ECO Employee 10b5-1 Plan or in the ECO Individual Retirement Account as specified in the ECO Employee 10b5-1 Plan. The short strike of the short vertical call spread will be the same as the 5 year LEAP ECO calls or a short strike which is 15% above the underlying value of the common stock whichever is higher. The long call part of the short vertical call spread will be 10% above the strike of the short call.

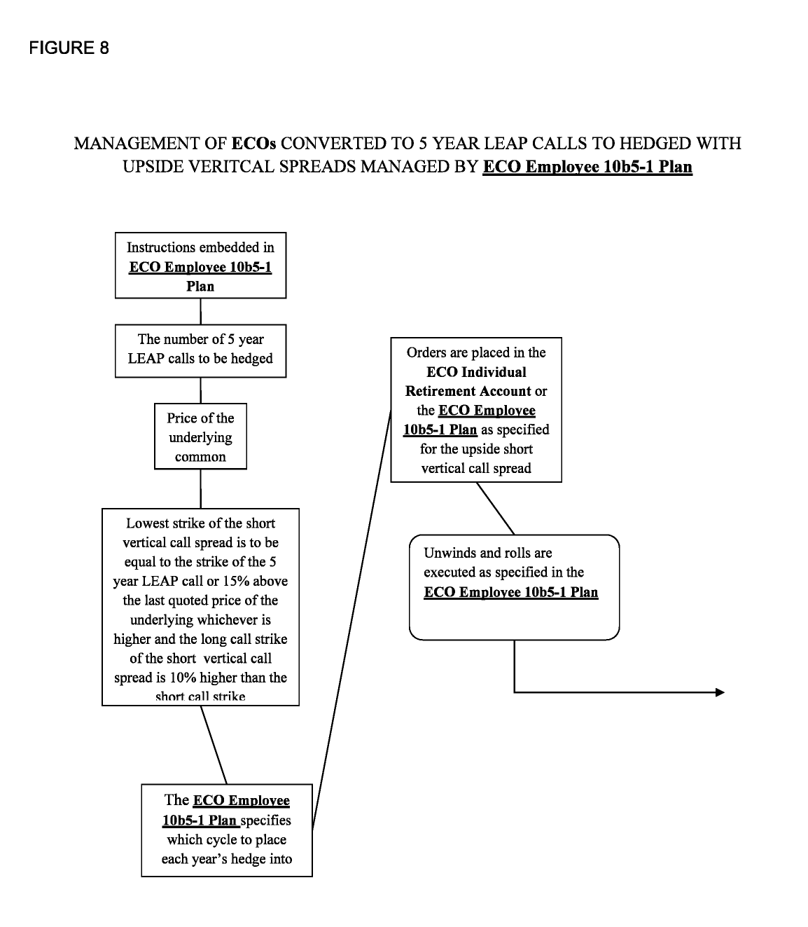

FIG. 8 is a flow chart for management of Employee Convertible Options converted to 5 year Long Term Equity Anticipation Securities (LEAP) with upper vertical spreads within the Employee Convertible Option Employee 10b5-1 plan. As shown in the figure, the ECO Employee's 10b5-1 Plan can also be structured that that short call of the short vertical call spread be allowed to be a qualified covered call against vested or restricted stock. This conversion feature would occur as rather than buy back the short vertical call spread on the Wednesday of expiration week, the short call would be allowed to be assigned against established long stock with expiration Friday, the long call would be sold that Wednesday, and the roll to the next cycle would occur the same Wednesday. That Wednesday, the next designated cycle specified in the ECO Employee 10b5-1 Plan will be sold either in the ECO Employee 10b5-1 Plan or in the ECO Individual Retirement Account as specified in the ECO Employee 10b5-1 Plan. The short strike of the short vertical call spread will be the same as the 5 year LEAP ECO calls or a short strike which is 15% above the underlying value of the common stock whichever is higher. The long call part of the short vertical call spread will be 10% above the strike of the short strike.

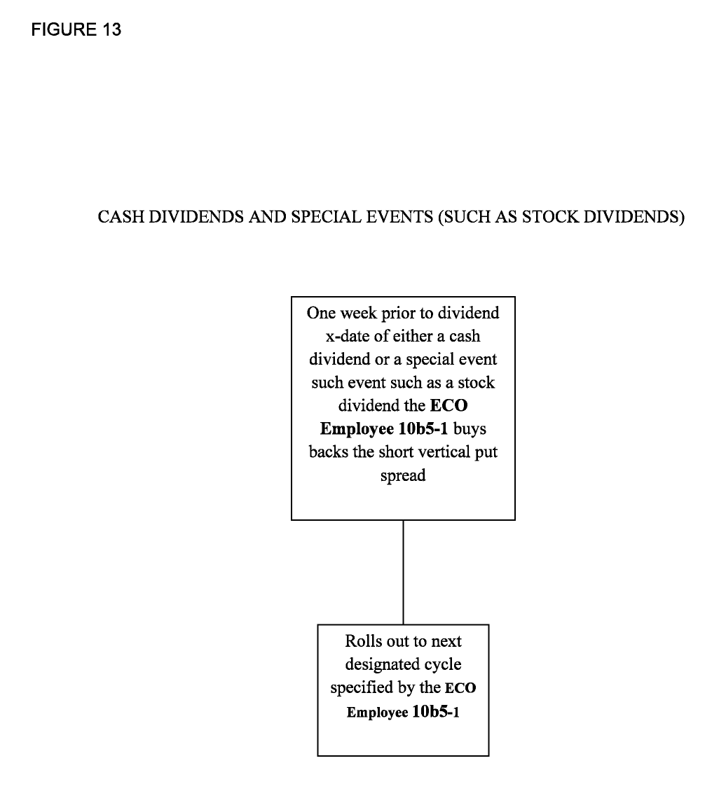

Whatever action taken, the ECO Employee's 10b5-1 Plan will than sell the next designated cycle's vertical call spread with the designated strike prices to be at least equal to the 5 year LEAP Contract ECO or 15% above the currently quoted market price of the underlying common stock and the long call of the spread will be a strike 10% above the short strike. These strikes will be determined automatically by the ECO Employee's 10b5-1 Plan. This would be an addition to the sale of vertical call spreads. With scheduled cash dividend dates or an unexpected special event such as a stock dividend announcement, 5 trading days prior to the x-dividend date of the event the ECO Employee's 10b5-1 Plan will buy back the short call spread and sell the next schedule cycles short vertical call spread embedded in the ECO Employee's 10b5-1 Plan. See, e.g., FIG. 13, which is a flow chart representing how cash dividends and other distributions should be granted to Employee Convertible Option Employee 10b5-1 plan.

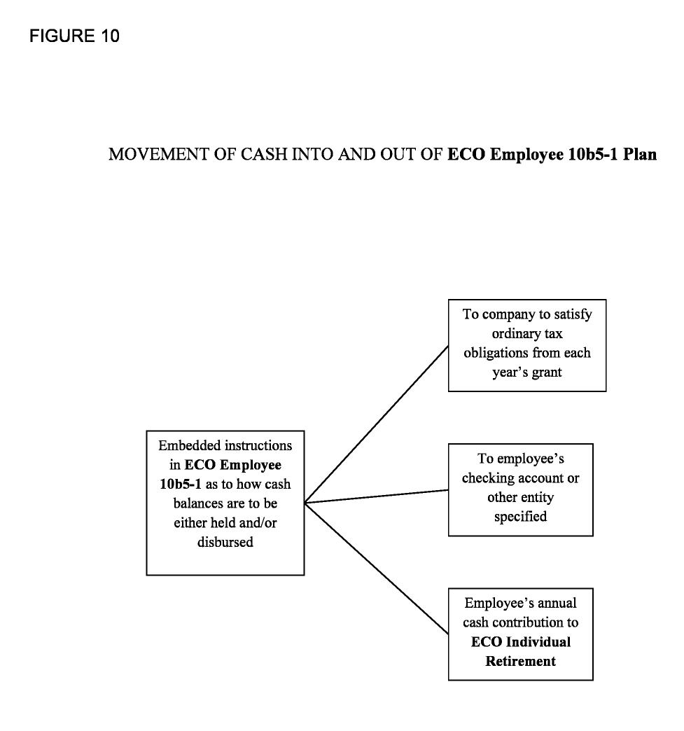

FIG. 10 is a flow chart representing how cash is moved into and out of for Employee Convertible Option Employee 10b5-1 plan.

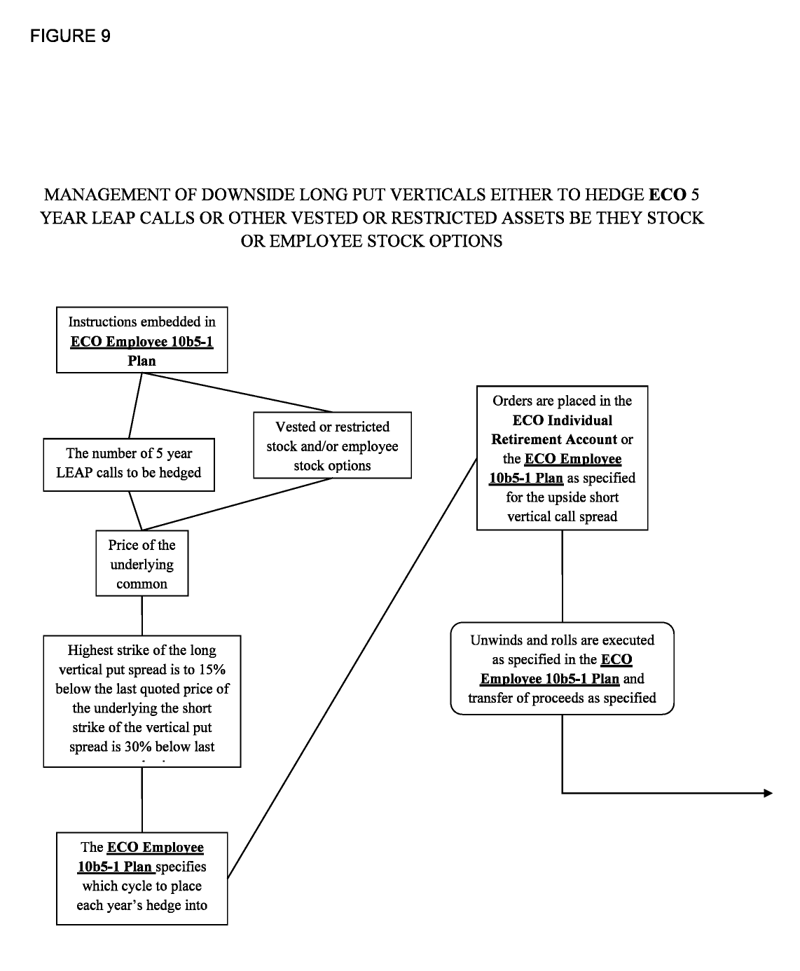

FIG. 9 is a flow chart for management of Employee Convertible Options converted to 5 year Long Term Equity Anticipation Securities (LEAP) or other vested or restricted assets with downside long put verticals within the Employee Convertible Option Employee 10b5-1 plan. Referring to that figure, another advantage and a reflection of the convertible features of the Employee Convertible Option (ECO) is that in the ECO Employee's 10b5-1 Plan the employee has the ability to purchase downside vertical put spreads. The employee can purchase these spreads separately or in conjunction with the sale of vertical call spreads in his ECO Employee's 10b5-1 Plan or ECO Individual Retirement Account. The employee because of his ECO grants and the conversion to a hedgeable 5 year LEAP calls will be able to lessen risk (or apply portfolio insurance) of an underlying common stock decline which would impact other grant assets of vested Restricted Stock or Employee Stock Options. This would be done through embedded parameters of the ECO Employee's 10b5-1 Plan with the purchase of downside put vertical spreads in 6 month puts, 9 month put, 1 year, or 2 year LEAP regulated put options. The long side of the downside vertical put spread will be 15% below the current price and the short side of the long vertical put spread will be 30% below the current price. Here follows a more detailed analysis of how the ECO Employee's 10b5-1 Plan will manage one of three different scenarios on the Wednesday of expiration week of the long put spread.

If the underlying stock should decline beyond the short side of the long put spread than the position is flat. The ECO Employee's 10b5-1 Plan will capture the premium between the long strike and short strike of the put spread minus the purchase price. This process will offset or hedge losses experienced with other employee grant assets. The ECO Employee's 10b5-1 Plan will roll the next downside put spread into the next cycle. The long side of the downside put spread will be 15% below the current price with the short side of the spread will be 30% below the current price.

If the long put spread should end with the stock settling at expiration at some level inside the two strikes of long and short puts the ECO Employee's 10b5-1 Plan will as in example (1) capture the premiums of the short call spread but also the employee's ECO Employee's 10b5-1 Plan will capture the increased put premium of the long put side of the spread and in addition the net proceeds of the short put side of the spread. In this example the ECO Employee's 10b5-1 Plan sell the soon to expire put spread and purchase or “roll out” to the next cycle specified in the ECO Employee's 10b5-1 Plan. The long side of the downside put spread will be 15% below the current price with the short side of the spread will be 30% below the current price.

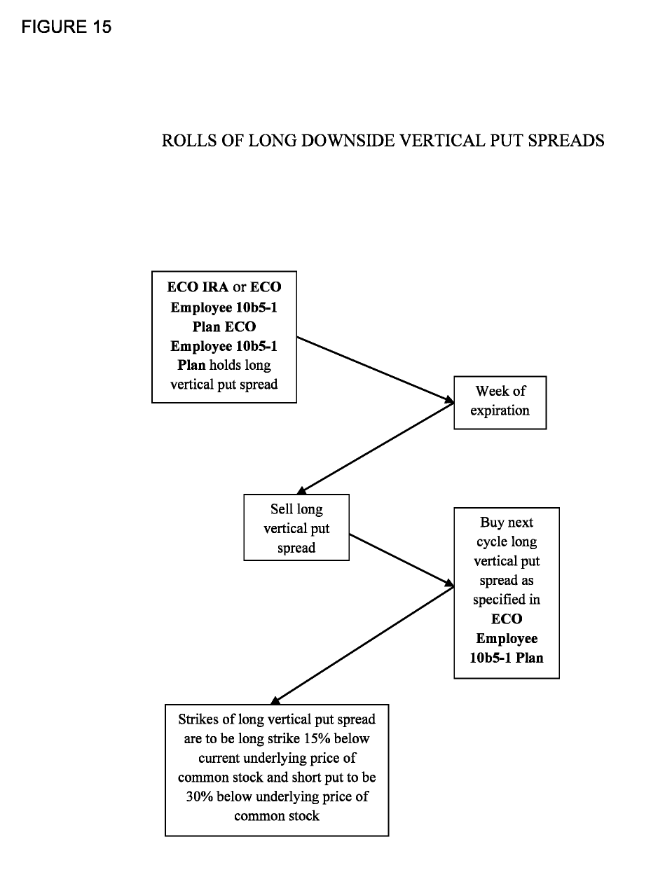

FIG. 15 is a flow chart representing the rolls of long downside vertical put spreads the last scenario action for the long put spread is if the underlying common were to close out of the money of the long put spread. In this scenario the ECO Employee's 10b5-1 Plan, will roll out into the next option cycle specified in the ECO Employee's 10b5-1 Plan. If the position is not rolled out to the next cycle the vested stock in the ECO Employee's 10b5-1 Plan will have lost the risk insurance provided by the downside put spread. The simultaneous sale of an upside call spread with the purchase of a downside put spread can be accomplished at a zero (0) cost or near zero (0) cost basis in the ECO Employee's 10b5-1 Plan or ECO Individual Retirement Account (IRA).

The employee will have short term losses or gains from the downside vertical long put spread and the upside vertical short call spread which could be advantageously captured in the ECO Individual Retirement Account (IRA) which is embedded in the ECO Employee's 10b5-1 Plan. The components of all four sides of the short upside call spread and the long downside put spread will be classified as an identified straddle which will be lodged in the employee's ECO Employee's 10b5-1 Plan personal ECO Individual Retirement Account (IRA). This particular separation of the Employee Convertible Option (ECO) will generate significant tax savings for the employee.

Another significant advantage of the Employee Convertible Option (ECO) to the employee is the opportunity of converting his holding period of his 5 year LEAP calls to an asset which would be classified as a long term capital gain. So, ideally, the employee could take his short term gains or losses of the short upside vertical call spread and/or of the long downside vertical put spread in his Plan Individual Retirement Account while at the same time converting his 5 year LEAP calls to a long term capital gain and more favorable tax treatments in the ECO Employee's 10b5-1. The following Private Letter Ruling acknowledges the Internal Revenue Service's acceptance of this practice.

The employee through his ECO Employee's 10b5-1 Plan also has the capability to structure the purchase of common stock and/or long equity options under stock ownership guidelines. This could be structured to engage via instructions of the ECO Employee's 10b5-1 Plan when the underlying common stock reached certain levels or in designated periods.

With an Individual Retirement Account embedded into the ECO Employee's 10b5-1 Plan the employee will be better able to manage and cross evaluate overall portfolio risk of all of his investments in conjunction to his compensation grants in addition to making his permitted annual contribution.

ECO Advantages for Regulatory Scrutiny and Disclosure Requirements

The Employee Convertible Option (ECO) with the imbedded ECO Employee's 10b5-1 Plan would fulfill requirements of Sections 955 of the Dodd-Frank Wall Street Reform and Consumer Protection Act of 2011, which mandates full disclosure and transparency for all employee grant contracts. The ECO adequately fulfills this mandate on all levels.

With the ECO Employee's 10b5-1 Plan the ECO conforms to stipulations by the SEC that trades are not made by the employee “on the basis of material non-public information. Once the ECO Employee's 10b5-1 Plan is created the employee has no further input into the actions of the ECO Employee's 10b5-1 Plan. With this restriction the employee is afforded an “affirmative defense” in respect to accusations of insider trading.

On the date of the grant and after the Request for Quote, there is a 30 day window suggested by Rule 10b5-1 of the Securities Exchange Act of 1934 before the ECO Employee's 10b5-1 Plan is initiated. After the Employee Convertible Option (ECO) undergoes the conversion to a regulated 5 year LEAP call this asset now comes under the providence of the SEC.

Currently, grants of Restricted Stock and Employee Stock Options Grants have come under regulatory and public scrutiny as there have been accusations that insiders on the day of Restricted Stock and/or Employee Stock Option Grants have manipulated the underlying common stock downwards to provide themselves with a more favorable grant price. This would not occur with Employee Convertible Option (ECO.

The practice of back dating Employee Stock. Options would no longer be an issue given the structure of the Employee Convertible Option (ECO).

The practice of re-granting Employee Stock Options which were deeply underwater to a more favorable price would no longer be an issue because of the Employee Convertible Option (ECO).

In all respects, the Employee Convertible Option (ECO) in its conversion to a 5 year LEAP calls will always maintain some intrinsic value up to the date of expiration.

For the 5 year LEAP calls and other vested securities, the hedging practices and the sale of these assets are covered in the ECO Employee's 10b5-1 Plan.

ECO Advantages to the Company

Employee Convertible Option (ECO) compensation grants improve on current practices of company stock grants and employee stock option grants.

With the Employee Convertible Option ECO the employee can convert to cash a number of grants on the first day of each year of the grant, but the balance are converted to a 5 year LEAP call which with conversion create a short position held by the company of the 5 year LEAP calls at the stated price.

Under terms of the ECO Contract, the Employee Convertible Option (ECO) is a 25% out of the money 5 year LEAP call contract whereby the company through the use of FLEX transactions the ECO Company 10b5-1 Plan is short the 5 year LEAP calls.

With the ECO Company 10b5-1 Plan the company will hedge with early, planned purchase of company common stock under the ECO Company 10b5-1 Plan before the call Employee Convertible Option (ECO) grant contract becomes “in the money”.

In any analysis the corporation could therefore recapture the expense of the Employee Convertible Option (ECO) coupled with the potential of capital gains with timely stock purchase.

This is practice provides favorable tax treatment to the company portfolio for a position which is essentially a covered write of a qualified covered call. The company converts an expense liability to an asset of cash.

It allows the company to realize stock appreciation in later years while the company is booking an expense in prior reporting years. [A separate area of this document will discuss the methodology of hedging in the ECO Company 10b5-1 Plan which companies would employ to effectively hedge the Employee Convertible Option (EGO).]

In light of the employee having the opportunity to receive cash on the date of the ECO Employee's 10b5-1 Plan initiation, the structure of the employees total compensation package allows the company to negotiate future contracts which are more favorable to the company.

Due to the embedded the nature of ECO Employee's 10b5-1 Plan the company will be indemnified from any malfeasance by the employee. The Employee Convertible Option (ECO) most importantly will satisfy all covenants and requirements of Section 955 of the Dodd-Frank Act on all levels.

The ECO Employee's 10b5-1 Plan will not only provide transparency to regulatory agencies but will also become a cost effective benefit due to there no longer being a need for the company to engage in protracted legal disputes over allegations of “insider trading”.

With the structure of ECO Employee's 10b5-1 Plan the employees will spread the ECO sale transactions over an extended period further establishing regulatory transparency.

Due to the structure of ECO Employee's 10b5-1 Plan and the ECO Company 10b5-1 Plan both the corporate counsel and trading compliance officers would not be mandated to make subjective determinations about the availability or possession of material non-compliance information similar to what occurs each time an employee should undertake a sale of Vested Restricted Stock or Employee Stock Options.

Due to the ECO Employee's 10b5-1 Plan and the ECO Company 10b5-1 Plan the company is less likely to be subjected to adverse publicity because of perceived insider trading violations.

The difficulties that surround “clawbacks” or return of employee compensation with the advent of unforeseen events would not be an issue with Employee Convertible Option (ECO).

The company who offers Employee Convertible Option (ECO) will have a recruiting advantage over competitors when it comes to securing contractual employment commitments of desirable employees.

To the employee who receives Employee Convertible Option (ECO) the financial advantages of the compensation grant and the duration of the grant provide a compelling incentive for the employee's continued employment with the company.

Given that the Employee Convertible Option (ECO) is stipulated as an out of the money call which would increase in value as the underlying common appreciates, this would align the employee to the company's future and lessen incentives for mobility of employees to competitors.

The company can elect to expand the 5 year grant of Employee Convertible Option (ECO) either at the end of the 5 year period of the ECO or over a sequential cycle of years which fits the company's objectives for retention of desirable employees and gives the company flexibility and leverage.

Due to the structure of the ECO Employee's 10b5-1 Plan employees can receive the benefits of long term capital gains, receive additional income, shelter assets in an ECO Individual Retirement Account with its more favorable tax treatment, and provide the employee the opportunity for extended estate planning. This reality benefits the company during employee/company salary negotiations in future periods.

Methodology for the Company to Hedge ECO Grant Contracts with the Eco Compay 10B5-1 Plan

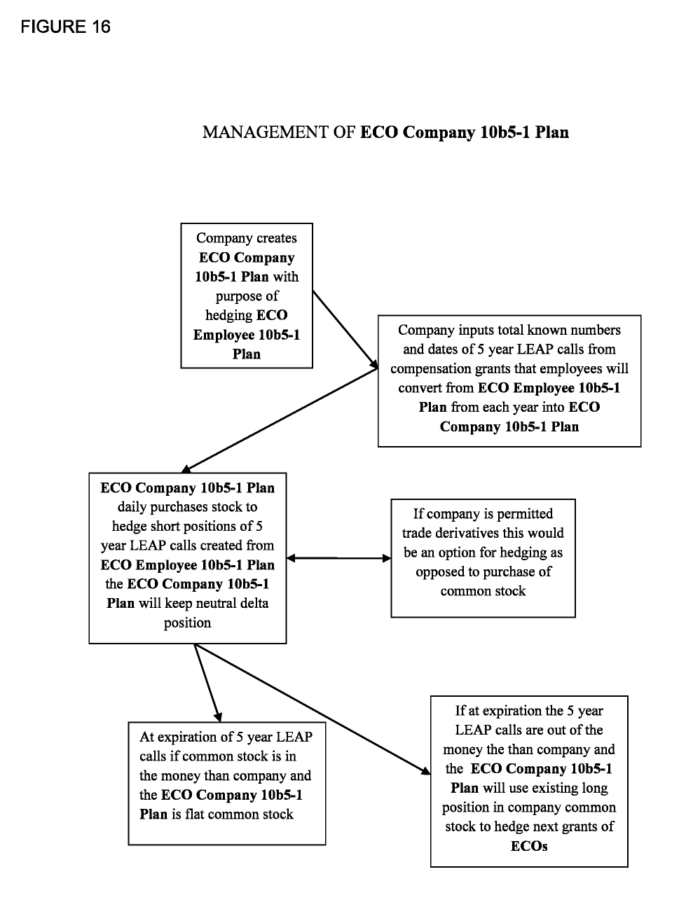

FIG. 16 is a flow chart representing how the Employee Convertible Option

Company 10b5-1 plan shall be managed. As shown in the figure, design a 10b5-1 plan called the ECO Company 10b5-1 Plan may be developed by a company. Using the plan, the company will can hedge short positions created by employees through their ECO Employee's 10b5-1 Plan. With certain levels of pricing and obligations the ECO Company 10b5-1 Plan will effectively purchase company stock to maintain the company in a delta neutral balance with reference to the company's short positions of 5 year LEAP calls.

With the ECO Employee's 10b5-1 Plan being on record, the corporation via the content of the Employee Convertible Option Contract will have a specific outline of the employee's ECO intentions at time of signing. The dates and precise number of ECOs either to be converted to cash on grant date or to converted from ECOs to 5 year LEAP calls will be known.

The ECO Company 10b5-1 Plan can transmit instructions to their Broker Dealer as to when, in what amounts, and at what pricing of company stock that needs to be purchased to satisfy anticipated needs of the Employee Convertible Option (ECO) contracts and keep the company delta neutral for this obligation . . . .

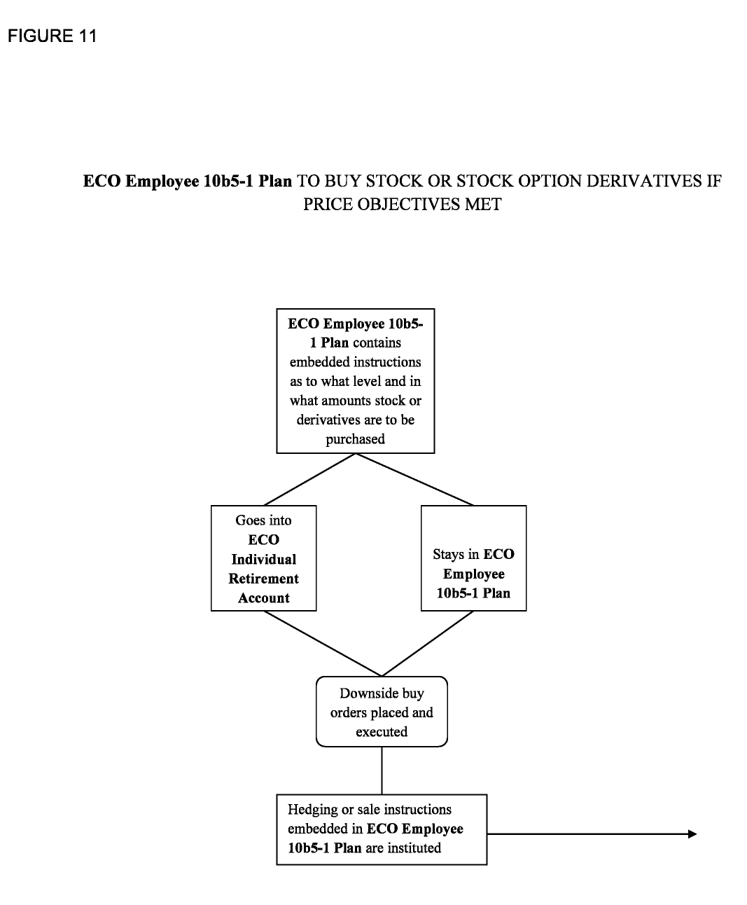

If a company's prospectus allows the use of derivatives either in the form regulated equity options, swaps, warrants, etc. than these would be additional alternative assets with which to hedge the company's Employee Convertible Option (ECO) employee grants. The company can best sort out the most advantageous manner to hedge employee ECOs once a determination is made of what investments are available. FIG. 11 is a flow chart representing how an Employee Convertible Option Employee 10b5-1 plan may be used to buy stock or stock option derivatives if price objectives are met.

Given the size and nature of the Employee Convertible Option (ECO) it is recommended that the timing of all grants be spread over all calendar months. The ECO Company 10b5-1 Plan effectively deals with “black out windows” and other significant time periods.

The benefits to the company in capturing additional income from an effective ECO Company 10b5-1 Plan by the initiation of prudent hedging of the Employee Convertible Option (ECO) which will create additional revenue are apparent. The company because of this would be a stronger position to offer additional grants of Employee Convertible Option (ECO) to employees. Also, because of the “affirmative defense” afforded by a structured ECO Company 10b5-1 Plan all of the Dodd-Frank Act requirements are met by the company.

ECO Advantages to the Shareholder

Shareholders principal motivation for investment is stock appreciation, virtually all of the benefits that the corporation derives from the Employee Convertible Option (ECO) and the ECO Employee's 10b5-1 Plan will have a positive effect on earnings, perceptions, and long term growth of the company and therefore the value of the underlying common stock will reflect this structural improvement.

The mandatory inclusion of the ECO Employee's 10b5-1 Plan and the restrictive nature of all 10b5-1 plans should curtail discomfort shareholders may feel regarding employees enhancing personal fortunes with undisclosed “non-public” information to the detriment of shareholder interest.

The Employee Convertible Option (ECO) because the grant is an out of the money call and the conversion to 5 year LEAP calls by the Employee Convertible Option (ECO) would more closely align the interests of the shareholder with those of the employee. This would more closely resemble the holding periods of shareholders and both would mutually benefit by upward appreciation of the underlying common stock.

The ability of the company through its ECO Company 10b5-1 Plan to expense and then recapture with additional company revenue Employee Convertible Option (ECO) compensation grants will add to quarterly earnings of the company. This will be reflected and accompanied with underlying stock appreciation.

Tax Disclosure

Tax Character Mismatch—

The tax considerations that arise from hedging vested or unvested employee stock options are complex. One primary difficulty encountered in hedging employee stock options from a tax perspective is that all gains from the underlying employee stock option are typically taxed as ordinary income. By contrast, gains or losses from any non-employee (exchange-traded or OTC) stock option hedges are treated as capital gains or losses. One the compelling features of the Employee Convertible Option (ECO) is the ability to address both forms of taxation efficiently through the conversion features. On the date of the grant the employee is subject to ordinary income on the actual valuation of the Employee Convertible Option (ECO). When the conversion to a 5 year LEAPS the new entity is subject to short term capital gains and losses and with length of holding period the ECO could be classified as long term capital gain.

Tax Consequences of 1092 Identified Straddle—The Identified Straddle rule is not applicable in this instance as by the action of selling upside vertical call spreads or by the buying of downside put verticals relieve the long term 5 year LEAP in the ECO Employee's 10b5-1 Plan to be considered as a long capital gains.

Tax Consequences of Placing Hedges in IRA—As only $3,000 of short term capital losses are allowed to be deductible in a trading account. By placing the upside vertical call spreads and the downside vertical put spread in an IRA, short term capital gains and losses receive benefits granted for the life of the Individual Retirement Account.

Computer Software

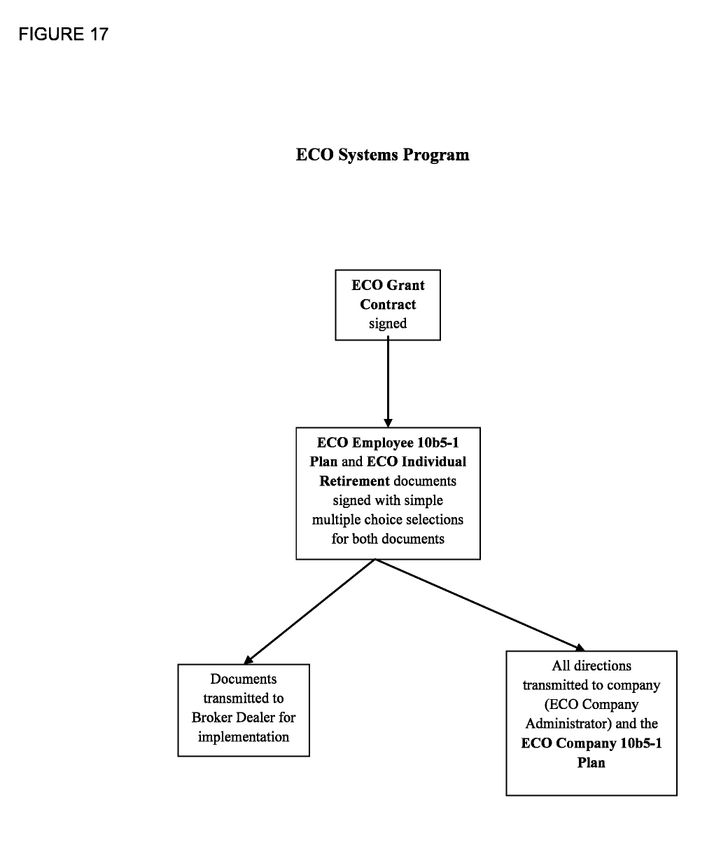

FIG. 17 is a flow chart representing how the Employee Convertible Option 10b5-1 plan management software shall function. Given the large number of sophisticated, complex tasks that are to be performed in the various segments of this technology an ECO Computer Software Service may be an integral component of the technology. The employee may at ECO grant signing be supplied with documentation outlining all aspects of the ECO, the ECO Employee's 10b5-1 Plan, and the Individual Retirement Act documents. The employee on grant signing and the creation of his ECO Employee's 10b5-1 Plan will have a simple multiple choice form to specify actions to be taken over the 5 year life of the ECO Employee's 10b5-1 Plan. Here are some of the features of the ECO Computer Software. The grant features will be determined and the stated payment method of ordinary income to the company for each year's grants of the ECO. The various components and instructions of the ECO Employee's 10b5-1 Plan will be implemented into a customized computer program for each employee. The ECO Computer Software will during the life of Grant Contract require no further input either from the employee, the corporation, or any regulatory body. If the employee should so specify, the ECO Computer Software will manage the transfer of funds into or out of the employee's personal bank or other designated banking entity. The ECO Computer Software will manage all aspects of the ECO Company 10b5-1 Plan.

Early Termination of the Employee

The ECO Employee's 10b5-1 Plan upon early termination of the employee will no longer be active. The ECO Individual Retirement Account will be taken out of the ECO Employee's 10b5-1 Plan and transferred to the designated agency specified by the employee at time of ECO Employee's 10b5-1 Plan signing. The ECO Company 10b5-1 Plan will adjust the programmed number of 5 year LEAP calls that were designated to be hedged.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

### PAPER “SEQUENCE LISTING”

Not applicable.

I claim:

1. A system of providing employee compensation in the form of employee convertible options to allow an employee to utilize a compensatory security option in employee options compensation packages.
